(19) United States
(12) Patent Application Publication
(10) Pub. No.: US 2013/0291889 A1
(43) Pub. Date: Nov. 7, 2013

(54) FLOSS PICK

(71) Applicants: Walter Prokopchuk, King City (CA); Robert G. Dickie, King City (CA)

(72) Inventors: Walter Prokopchuk, King City (CA); Robert G. Dickie, King City (CA)

(21) Appl. No.: 13/934,780

(22) Filed: Jul. 3, 2013

Related U.S. Application Data
(63) Continuation of application No. 13/039,867, filed on Mar. 3, 2011.
Application No. 13/039,867 is a continuation-in-part of application No. 12/939,618, filed on Nov. 4, 2010, now Pat. No. 8,375,961.

(51) Int. Cl. A61C 15/04

(52) U.S. Cl. CPC A61C 15/046
USPC 132/323

(57) ABSTRACT

A floss pick including a body with a handle and a head having a length of floss therein. The handle defines an aperture with a toothpick member disposed therein. The toothpick member is connected to the handle by first and second bridge members. In a first instance, the bridge members are broken to detach the toothpick member. In a second instance, the bridge members are twisted to pivot the toothpick member from a nonuse position to a use position where it is disposed at an angle relative to the body. The toothpick member is pivoted by engaging a terminal end thereof with an index finger of the hand in which the body is held. The angle of the toothpick member relative to the body is adjusted using the index finger to permit picking of the teeth in any region of the user's mouth without changing hands.

### CROSS-REFERENCE TO RELATED APPLICATIONS

This application is a Continuation of U.S. patent application Ser. No. 13/039,867, filed Mar. 3, 2011, which is a Continuation-in-Part of U.S. patent application Ser. No. 12/939,618, filed Nov. 4, 2010, now U.S. Pat. No. 8,375,961, the entire specifications of which are incorporated herein by reference.

### BACKGROUND OF THE INVENTION

1. Technical Field

This invention generally relates to oral hygiene. More particularly, the invention relates to floss picks. Specifically, the invention relates to a single use, disposable floss pick incorporating a pivotable toothpick member positioned within an aperture in the body. The user is able to pick their teeth in any part of their mouth simply by changing the angle of the toothpick member relative to the body by engaging the terminal end of the toothpick member with an index finger of the hand in which the body is held, and moving the terminal end in one of a first direction and a second direction.

2. Background Information

Floss picks are small, plastic, Y-shaped or F-shaped oral care devices that comprise a molded plastic frame into which a short length of floss thread is secured. These handy, single-use devices are sold in packs of 50 or more and are much easier to use than a traditional spooled floss that needs to be wrapped around one's fingers.

Floss picks can have a wide variety of handle styles that typically are shaped to end in a sharp point. The pointed ends are designed to be used as a toothpick. The combination of the floss and the toothpick aids the user in maintaining good oral habits. An example of a previously known floss pick is found in U.S. Pat. No. 5,692,531 (Chodorow) which discloses a floss pick that includes portions of the handle shaped to terminate in a sharp end which can then be used as a toothpick.

Presently known floss picks do, however, have a problem in that, if the user is not careful, they can prick the inside of their hands and fingers while they are using the floss end of the device. Some manufacturers have attempted to address this issue. For example, U.S. Pat. No. 5,829,458 (Chodorow) discloses a floss pick comprising a body made up of a head and a handle. The head includes two arms between which a length of floss is strung. The handle extends outwardly from the head. A toothpick is formed as part of the handle. The toothpick is not formed at the end of the handle remote from the head but is instead preferably formed along an edge of the handle. The handle also includes another portion that acts as a guard for the toothpick and prevents the user from being accidentally pricked by the toothpick. In certain embodiments of the '458 device, the user simply bends the guard out of the way when they wish to use the floss pick and bends it back into the way when they want to shield the pick. The problem with this device is that if the user decides to use the toothpick end of the device first, then the bent back guard is unable to maintain its position during the flossing operation after it has been moved back to the guard position. The user can then, once again, accidentally injure themselves on the toothpick because of the bent guard. Alternatively, instead of the guard being bent out of the way it may be completely removed from the floss pick to reveal the toothpick portion. In yet another embodiment of the '458 device, instead of the guard being bent out of the way, the toothpick is moved to bring it into a position where it can be used. A living hinge joins the outermost end of the guard to a portion of the toothpick. The living hinge is formed by providing a groove in the body of the floss pick which acts as a line of weakness which permits the body material to be folded back on itself. As the material is folded about the living hinge(s), the toothpick is rotated out of the handle and is moved until it extends forwardly from the outermost end of the guard. In this position, a portion of the toothpick is positioned adjacent the side wall of the dental implement so that there is a double thickness of the device in that region. The toothpick itself is offset from the plane of the floss pick's body. Some of the issues that this arrangement creates are that the toothpick cannot be locked into this use-position and once the toothpick has been folded into a use-position, it cannot readily be returned to its original nonuse position. One of the reasons for this is that the material at the living hinge will tend to stretch and elongate when folded so that the toothpick does not easily fit back into the cavity. The other reason is that returning the toothpick to its original position may cause the living hinge to break, detaching the toothpick from the body.

U.S. Pat. No. 867,264 to Evans discloses a dental implement that includes a floss pick and a toothpick. The floss pick has a body comprising a head portion and a handle portion. The head portion includes a pair of spaced apart arms with a length of floss extending therebetween. The toothpick is a separate component that is secured to the exterior surface of the body by way of a screw and a thumb nut. The body has a longitudinal axis extending from the end of the head and through the handle to a second end. The toothpick is configured to be rotated in a plane that is generally parallel to the longitudinal axis of the body and into a position where it will be used to pick the teeth. When the user wishes to pick their teeth, they have to hold the handle using one hand, loosen the thumb nut with the other hand, rotate the toothpick into the desired position relative to the handle and then tighten the thumb nut to lock the toothpick in place so that it may be used. If it is discovered that the angle of the toothpick is not suitable for effectively cleaning between adjacent teeth, the user will have to hold the handle in one hand and then use the other hand to loosen the thumb nut, rotate the toothpick to a new position and then tighten the thumb nut once again. This device would appear to be fairly clumsy to use as a toothpick as the ideal angle for use of the toothpick will be when it is disposed substantially at right angles to the body. This angle, however, will make it very difficult to manipulate and hold the body while picking the teeth. When the user no longer wishes to use the implement, they need to fold the toothpick back to its original position adjacent the exterior surface of the handle.

U.S. Pat. No. 3,783,883 issued to Alexander discloses a floss pick that includes a toothpick. The toothpick is disposed within a cavity in the handle of the floss pick and is connected to the handle by a pair of opposed frangible bridging elements. The toothpick is complementary in shape to the cavity and is provided with two ends that taper from a middle region. The middle region is the widest portion of the toothpick and the bridging elements extend between the sides of the middle region and the handle. The cavity is provided in the interior of the handle as the sharpened ends thereof would otherwise potentially hurt the user when they are using the floss pick to floss their teeth. The toothpick is detached from the handle prior to use.

A second issue that has been evident with prior known devices is that the toothpick point itself is not thin enough to function in the same manner as a wooden toothpick would be able to do. The reason for this is fairly simple. The body of the floss pick is made from ABS or styrene plastic that has to be made so that it is approximately 0.08 inches thick. This thickness is necessary because the body will deform during use if the plastic is any thinner. The 0.08 inch thickness is usually tapered in two dimensions to form the sharpened end of the toothpick point. The points are similar to traditional wooden toothpicks. The ABS or styrene plastic is very much harder than wood and thus is more difficult to deform or crush to a sufficient degree to allow the point of the toothpick to enter narrower interproximal spaces between teeth.

There is therefore a need for an improved floss pick that addresses the safety issue of the sharpened point at the end of the floss pick handle and which includes a toothpick that is better able to reach into narrower interproximal spaces.

### SUMMARY OF THE INVENTION

The device of the present invention comprises a floss pick which includes a body with a handle and a head. The head has first and second arms defining a cavity between them, and a length of dental floss that extends between the arms and across the cavity. The body includes a toothpick member that preferably is disposed on the head and extends outwardly from one of the first and second arms into the cavity. The floss extends between the other of the first and second arms and the toothpick member and during use guides the toothpick member into interproximal spaces between teeth.

The toothpick member includes one or more blades and is tapered from adjacent the one of the first and second arms to an end remote therefrom. The one or more blades may be sinuous along their length or may be planar. A combination of sinuous and planar blades may also be utilized. In addition, an elastomeric sheath may be provided around an exterior surface of the blades so that the toothpick member may be utilized as a dental stimulator.

The handle preferably is oval in shape or includes an oval recess therein. The oval shaped handle or recess is configured to be grasped between a user's thumb and index finger.

As an alternative to the toothpick member on the head of the floss pick, the device may, instead, be provided with a detachable toothpick member on the handle. The toothpick member is connected to the handle by way of a first and a second bridge member. Preferably, this toothpick member extends forwardly toward the head of the floss pick and is initially coplanar with the front and rear surfaces of the handle so that it will not accidentally injure the user. Furthermore, the apex of the toothpick is preferably slightly rounded so that it additionally cannot accidentally hurt the user. When the user wishes to pick their teeth they apply a force to the toothpick member and this force breaks the first and second bridge members, detaching the toothpick member from the body.

In a second instance, the toothpick member is connected to the body by way of first and second bridge members that are differently dimensioned to the breakable bridge members. These first and second bridge members are longer and stronger than those that secure the detachable toothpick member to the body. Because they are longer and stronger, when a force is applied to the toothpick member, the longer first and second bridge members twist. In other words, the shape of the first and second bridge members is altered as at least one of the ends of each of the bridge members moves in a direction opposite to the other end of that bridge member. Consequently, the parts of the bridge member that were previously located in a straight line and plane prior to twisting, are now located in a spiral curve. This is unlike the motion that would occur if the toothpick member was simply folded back onto the body, such as is the case in U.S. Pat. No. 5,829,458. In that instance, prior to movement of the toothpick member, all of the parts of the living hinge that are located in a straight line and plane are still located in that straight line and plane when the folding motion is completed. The twisting motion stores spring energy in the first and second bridge members as the toothpick member rotates in response to the twisting. Consequently, when the user ceases to apply a force to the toothpick member, the first and second bridge members twist back to their original position, returning the toothpick member to its original position. First and second bridge members are twistable through about 180 degrees relative to the plane of the body. This twisting motion causes toothpick member 570 to be pivoted through about 180 degrees from a non-use position to a use position where it is disposed at an angle relative to the body. The toothpick member is pivoted by engaging a terminal end thereof with an index finger of the hand in which the body is held. The angle of the toothpick member relative to the body is adjusted using the index finger to permit picking of the teeth in any region of the user's mouth without changing hands.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective front view of a first embodiment of a floss pick in accordance with the present invention;

FIG. 2 is a front view thereof;

FIG. 3 is an enlarged perspective view of the highlighted region of FIG. 1;

FIG. 4 is a front view of FIG. 3;

FIG. 5 is a bottom view of FIG. 3;

FIG. 6 is a side view of FIG. 3;

FIG. 7a is a perspective front view showing the floss pick of FIG. 1 being used to floss the user's teeth;

FIG. 7b is a perspective front view showing the toothpick member of the floss pick of FIG. 1 being used to remove debris from an interproximal space;

FIG. 8 is a perspective front view of a second embodiment of a floss pick in accordance with the present invention showing an alternative handle design and an alternative toothpick design to those shown in FIG. 1;

FIG. 9 is a front view thereof;

FIG. 10 is an enlarged perspective view of the highlighted region of FIG. 8;

FIG. 11 is a front view of FIG. 10;

FIG. 12 is a bottom view of FIG. 10;

FIG. 13 is a side view of FIG. 10;

FIG. 14 is an enlarged front view of a third embodiment of a toothpick region of a floss pick of the present invention;

FIG. 15 is a side view of FIG. 14;

FIG. 16 is a front view of a fourth embodiment of a floss pick in accordance with the present invention showing yet another alternative handle design and an alternative toothpick or dental stimulator;

FIG. 17 is a cross-sectional view of FIG. 16;

FIG. 18 is an enlarged cross-sectional side view taken through line 18-18 of FIG. 17;

FIG. 19 is a rear view of FIG. 16 showing the floss pick held in the user's hand;

FIG. 20 is a side view of FIG. 19;

FIG. 21 is a front view of a fifth embodiment of a floss pick in accordance with the present invention;

FIG. 22 is an enlarged front view of the highlighted region of FIG. 21; and

FIG. 23a is a front view of the floss pick in accordance with FIG. 21, showing the toothpick member broken away from the body of the floss pick;

FIG. 23b is a perspective front view showing the toothpick member removed from the floss pick of FIG. 23a and being used to remove debris from an interproximal space;

FIG. 24a is a front view of a sixth embodiment of a floss pick in accordance with the present invention and showing the toothpick member in the original molded position;

FIG. 24b is an enlargement of the highlighted region of FIG. 24a;

FIG. 25a is a front view of the floss pick, showing the toothpick member swiveled or pivoted through approximately 180 degrees from its original position and into a use-position where it is substantially aligned with the body of the floss pick and illustrating the twisted first bridge member;

FIG. 25b is an enlargement of the highlighted region of FIG. 25a;

FIG. 26 is a top view of the floss pick showing the toothpick member positioned at an angle of 75 degrees relative to the body of the floss pick;

FIG. 27 is a top view of the floss pick showing the toothpick member positioned at an angle of 90 degrees relative to the body of the floss pick;

FIG. 28 is a top view of the floss pick showing the toothpick member positioned at an angle of 150 degrees relative to the body of the floss pick;

FIG. 29 is a perspective view of the floss pick of FIG. 28;

FIG. 30 is a top view of the floss pick being held in the user's hand and showing the toothpick member disposed at an angle of around 75 degrees relative to the body thereof and ready for use;

FIG. 31 is a top view of the floss pick being held in the user's hand and showing the toothpick member disposed at an angle of around 150 degrees relative to the body thereof and ready for use; and

FIG. 32 is a top view of a bottom jaw of a user showing the positioning of the floss pick at various locations relative to the jaw when held in a user's right hand and showing the varied positioning of the toothpick member at those various locations.

### DETAILED DESCRIPTION OF THE INVENTION

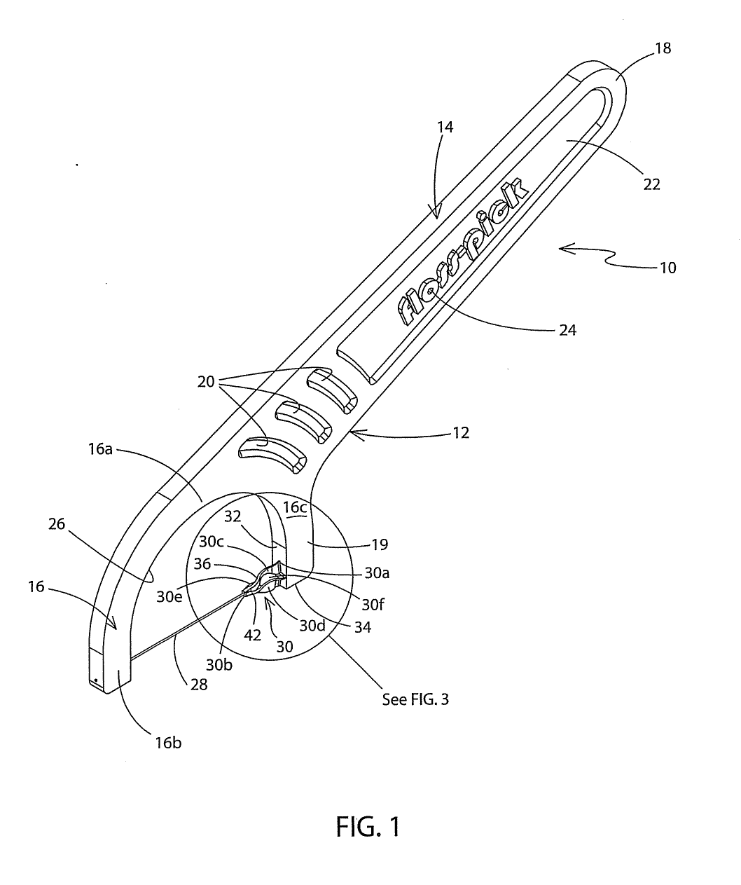

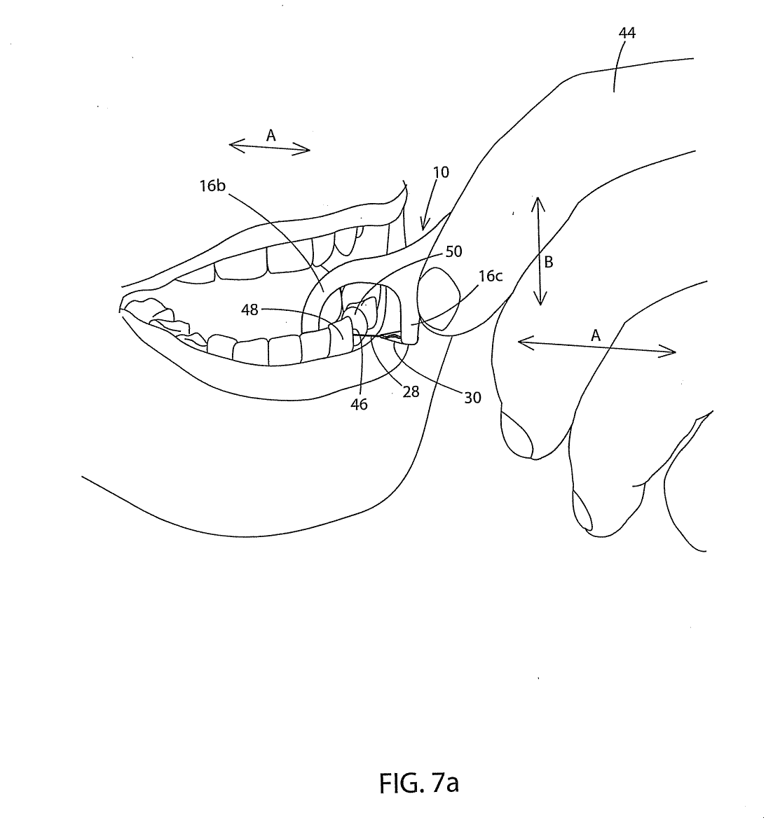

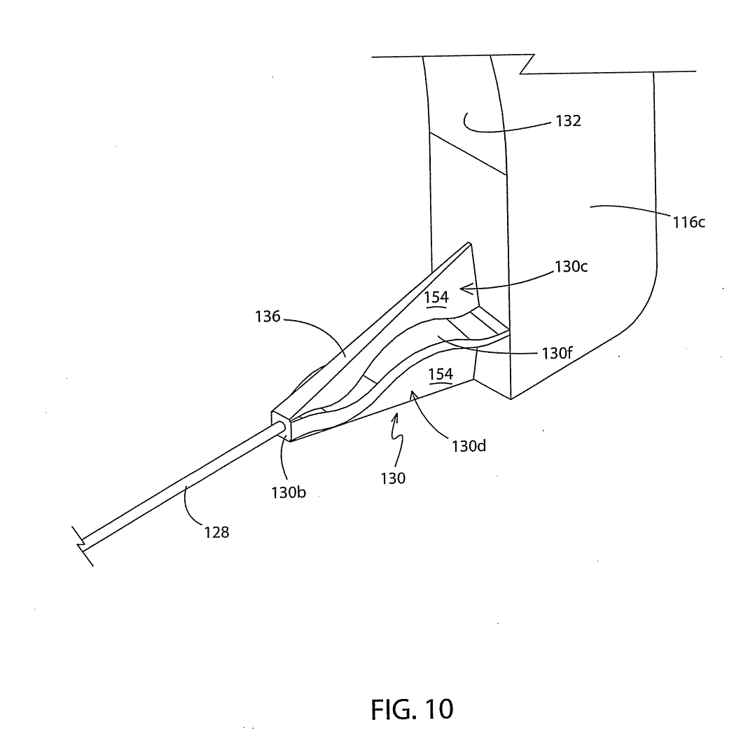

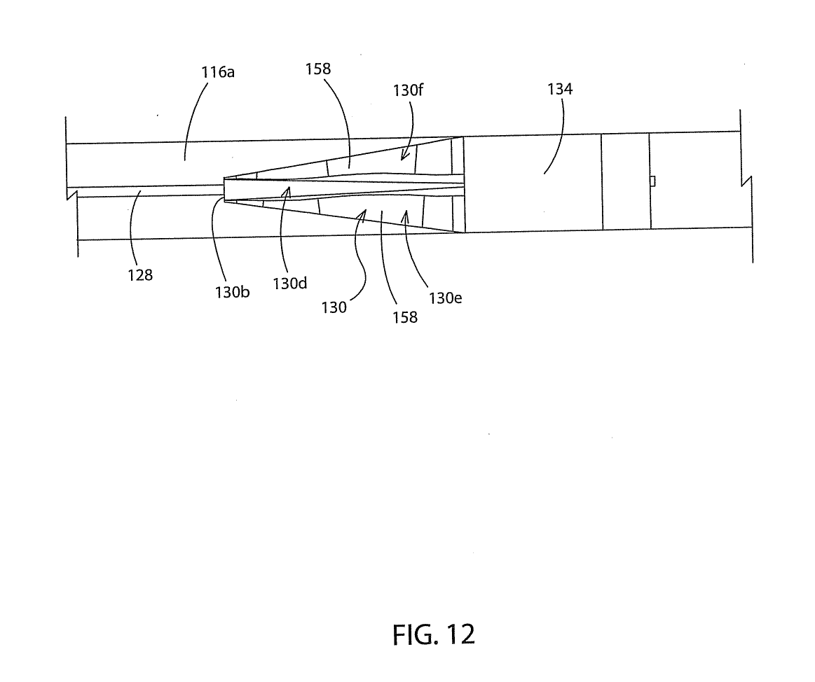

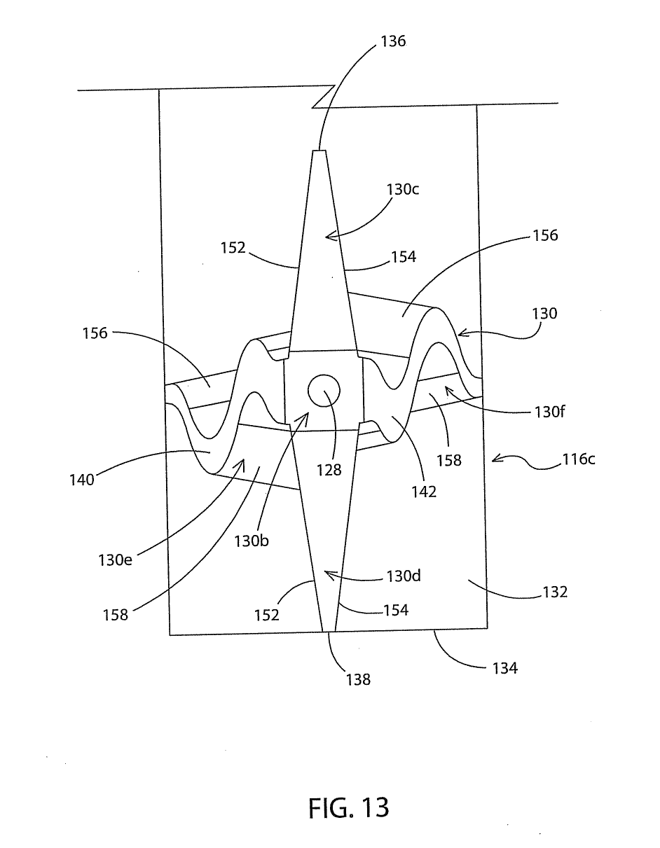

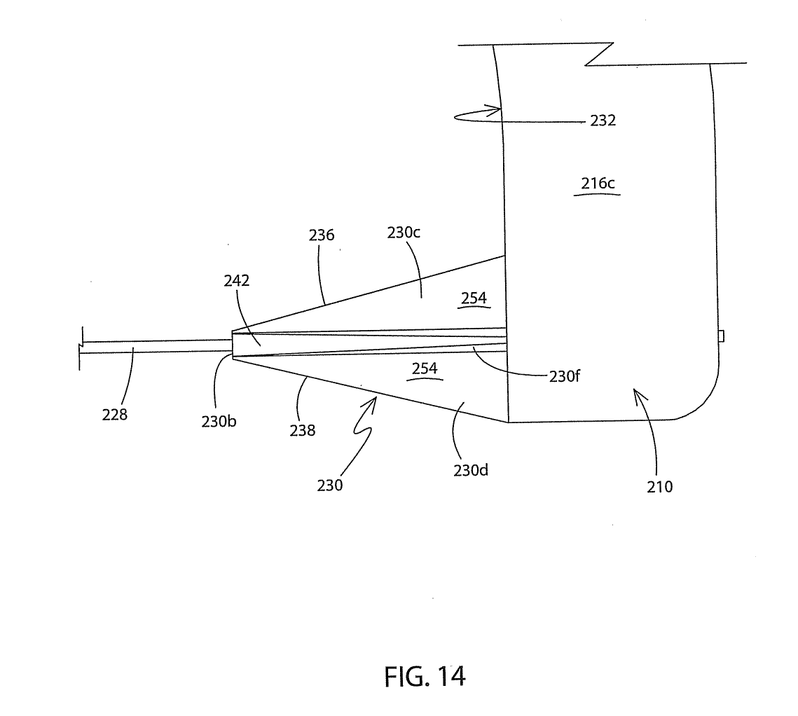

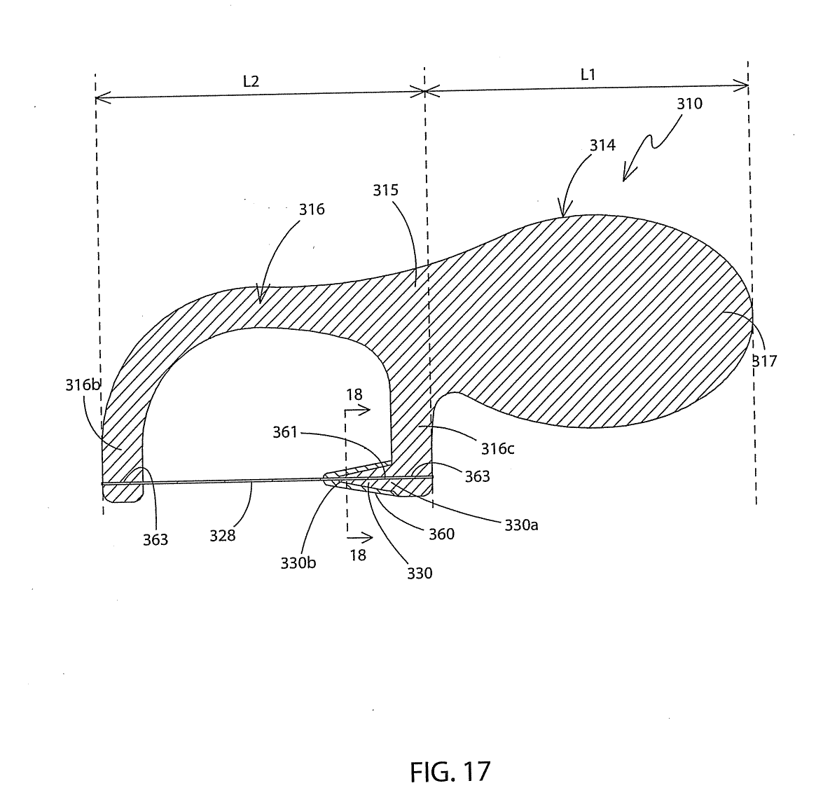

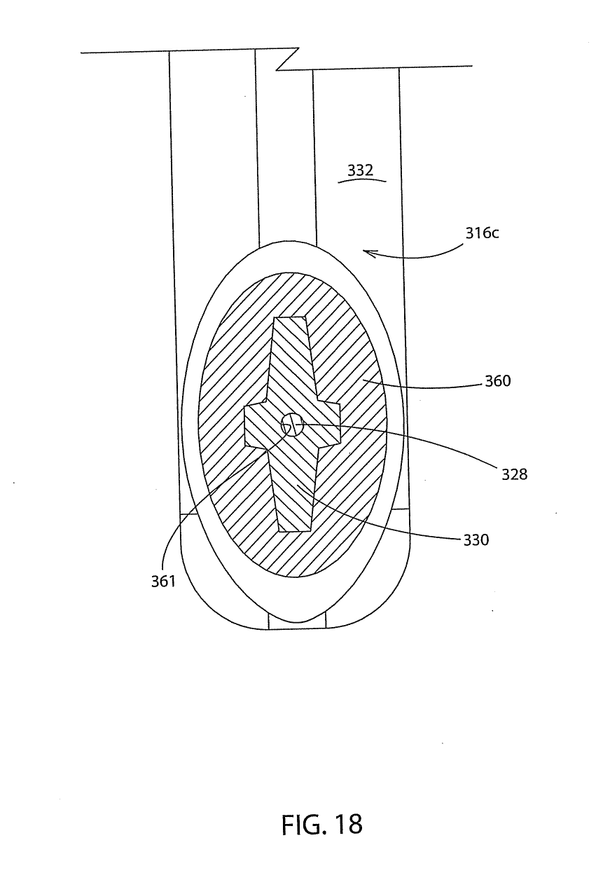

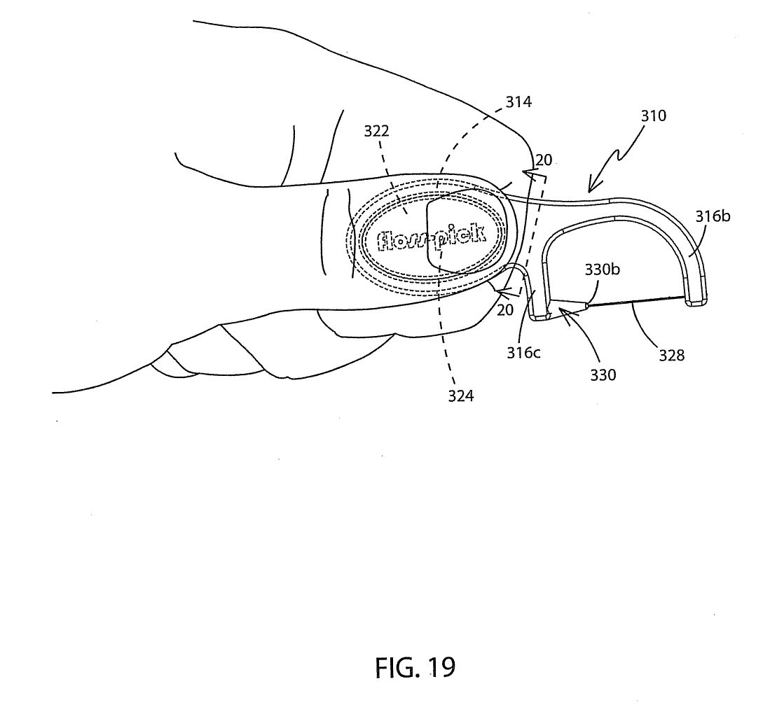

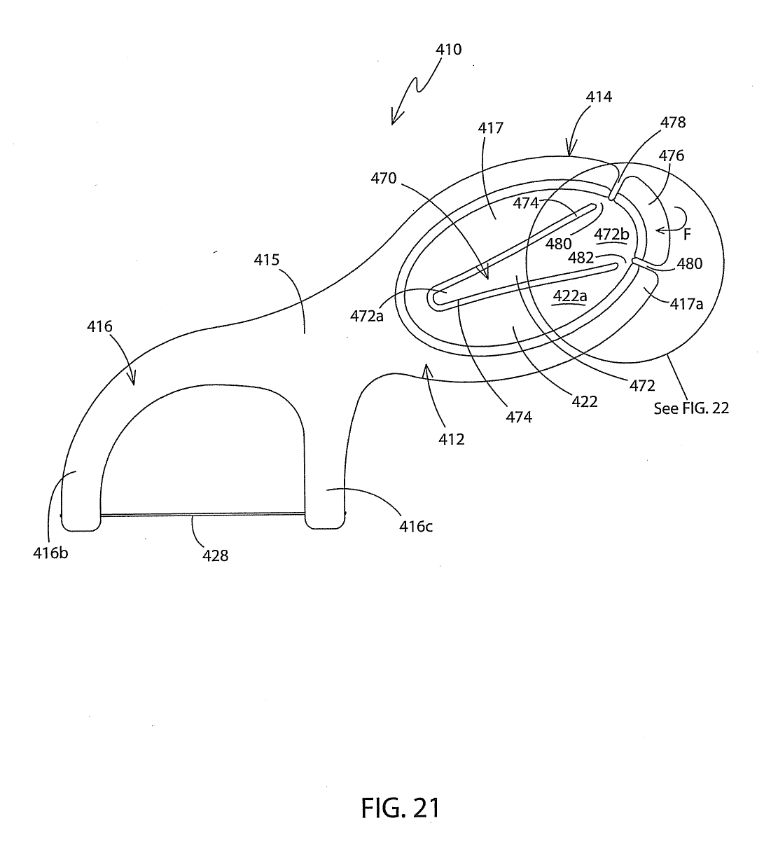

Referring to FIGS. 1-6, there is shown a first embodiment of a floss pick in accordance with the present invention and indicated generally at 10. FIGS. 7-12 show a second embodiment of a floss pick in accordance with the present invention indicated generally at 110. FIGS. 13 and 14 show a third embodiment of a toothpick region of a floss pick in accordance with the present invention, where the floss pick is indicated by the reference character 210. FIGS. 15-19 show a fourth embodiment of a floss pick in accordance with the present invention indicated generally by the reference character 310. Finally, FIGS. 20-23b show a fifth embodiment of a floss pick in accordance with the present invention and indicated by the reference character 410.

Floss picks 10, 110, 210, 310, and 410 preferably are single use, disposable picks that are injection molded from a suitable material such as Acrylonitrile Butadiene Styrene (ABS) plastic.

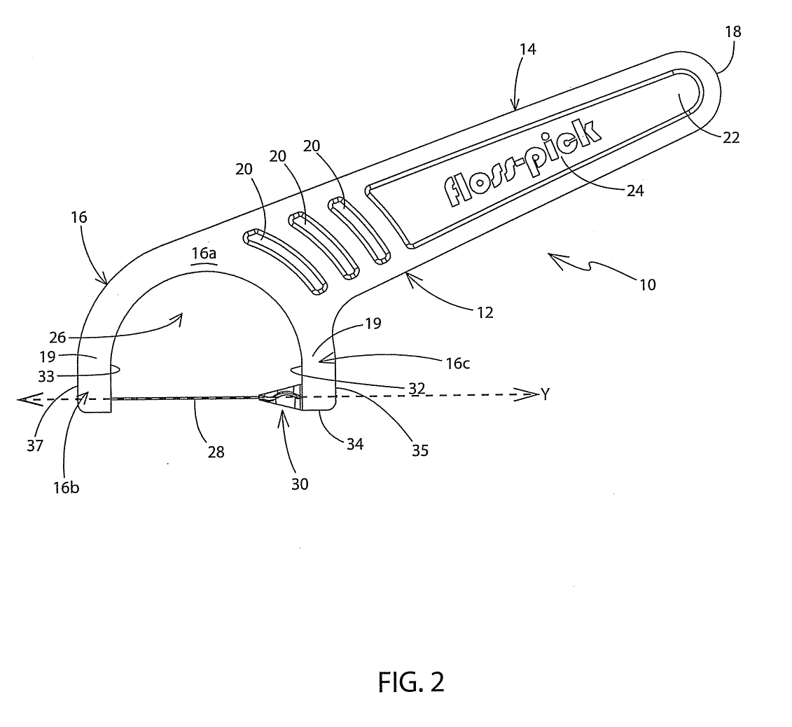

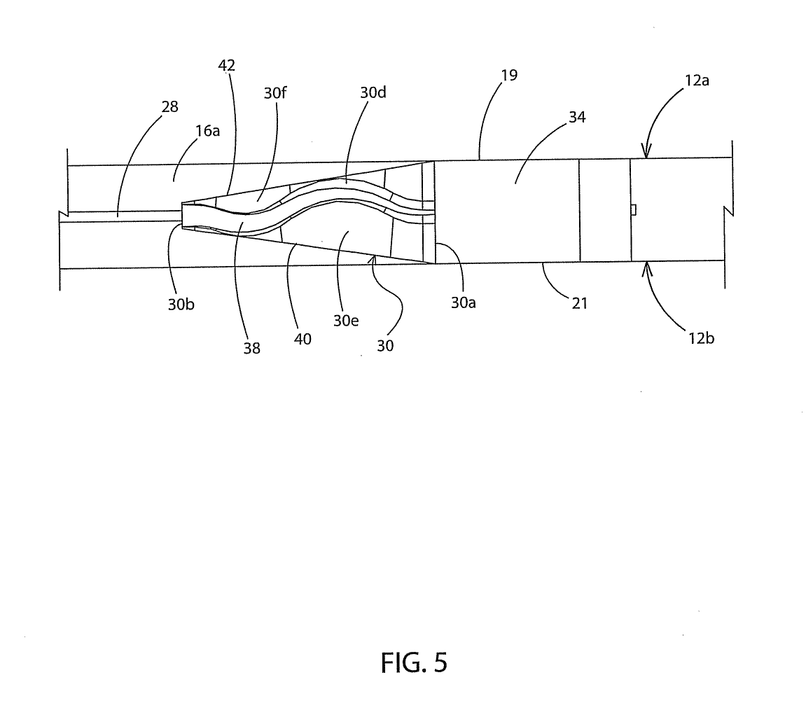

Referring to FIGS. 1-7b, floss pick 10 comprises a body 12 including a handle 14 and a head 16. FIG. 2 shows a front view of floss pick 10 and it should be understood that, although not illustrated herein, a rear view of floss pick 10 is substantially a mirror image of FIG. 2. Thus, body 12 has a front surface 12a (FIG. 2) and a rear surface 12b (FIG. 5) that are mirror images of each other. Head 16 preferably is disposed at an angle relative to handle 14 and body 12 is generally F-shaped. It will be understood, however, that body 12 of pick 10 may, alternatively, be generally Y-shaped or of any other suitable shape without departing from the scope of the present invention.

Handle 14 extends outwardly from an end of head 16 and tapers to a terminal end 18. In accordance with a specific feature of the invention, terminal end 18 preferably is gently rounded so that when pick 10 is held by a user, the terminal end 18 will not cause injury to the user's hand. Handle 14 preferably defines one or more cavities 20 that serve to reduce the amount of material required to produce pick 10. Pick 10 may also include a recessed region 22 defined in each of the front surface 12a and rear surface 12b of handle 14 of body 12. Only one of said recessed regions 22 is illustrated in the attached figures. Recessed regions 22 aid in reducing the amount of material required to produce pick 10. Recessed regions 22 also provide an area on each side of handle 14 upon which indicia 24 may be applied. Suitable indicia 24 include a brand name or instructions for use of pick 10. Indicia 24 preferably are molded or printed onto an interior wall of recessed region 22.

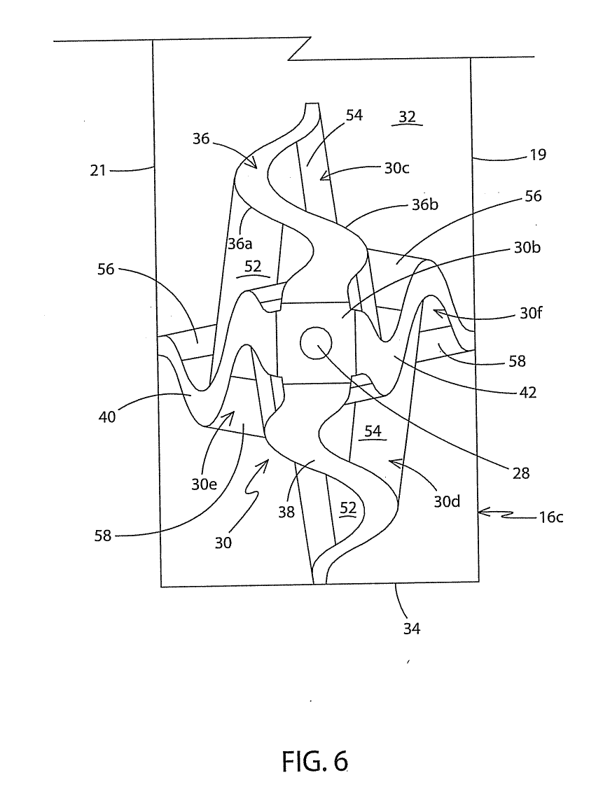

Head 16 preferably is generally U-shaped and includes a central region 16a, a first arm 16b and a second arm 16c. Central region 16a, and first and second arms 16b, 16c define a C-shaped cavity 26. Each of central region 16a, first arm 16b and second arm 16c has a front surface 19 (FIG. 6), a rear surface 21, and an interior surface and an exterior surface which extends between the front and rear surfaces 19, 21. The interior and exterior surfaces of first arm 16b are indicated at 33 and 35, respectively (FIG. 2), and the interior and exterior surfaces of second arm 16c are indicated at 32 and 37, respectively.

At least one length of floss 28 extends between first and second arms 16b, 16c and more specifically, between interior surfaces 33 and 32 thereof. Floss 28 extends across cavity 26 and may be disposed at any one of a number of angles relative to interior surfaces 32, 33. However, Floss 28 preferably is secured generally at right angles to interior surfaces 32, 33. Floss 28 preferably is fixedly secured in place so that it is retained under tension. It will be understood that head 16 may take other configurations that permit one or more strands of floss 28 to extend across an open region so that the floss is positioned to readily be engaged in the interproximal space 46 (FIGS. 7a, 7b) between the surfaces of two adjoining teeth (48, 50).

In accordance with a specific feature of the present invention, a toothpick member 30 is disposed on body 12. Toothpick member 30 specifically is provided on head 16. More specifically, toothpick member 30 is provided on one of first and second arms 16b, 16c and preferably is disposed on the one of the arms that is closer to the terminal end 18 of handle 14. In FIGS. 1-6, toothpick member 30 preferably is disposed on second arm 16c as this is the region of floss pick 10 that will engage the surface of the teeth when the user applies a pushing force on the pick 10 as opposed to a pulling force.

In accordance with yet another specific feature of the present invention, toothpick member 30 extends outwardly from interior surface 32 of second arm 16c and into cavity 26 and toward interior surface 33 of first arm 16a. FIG. 2 shows that floss 28 has an axis “Y” and toothpick member 30 has a longitudinal axis that is parallel to or aligned with the axis “Y” of floss 28. As shown in FIG. 6, preferably no portion of toothpick member 30 extends outwardly beyond one or both of the front and rear surfaces 19, 21 of second arm 16c. Still further, preferably no portion of toothpick member 30 extends beyond the outermost end 34 of second arm 16c. Toothpick member 30 is thus shielded from accidental contact by the user's hand during use of floss pick 10. It will be understood that it is possible for a portion of toothpick member 30 to extend slightly beyond one or more of front surface 19, rear surface 21 and outermost end 34 of second arm 16c but a second end 30b of toothpick member 30 preferably is always located inwardly of these surfaces so that a user will not accidentally come into contact with second end 30b.

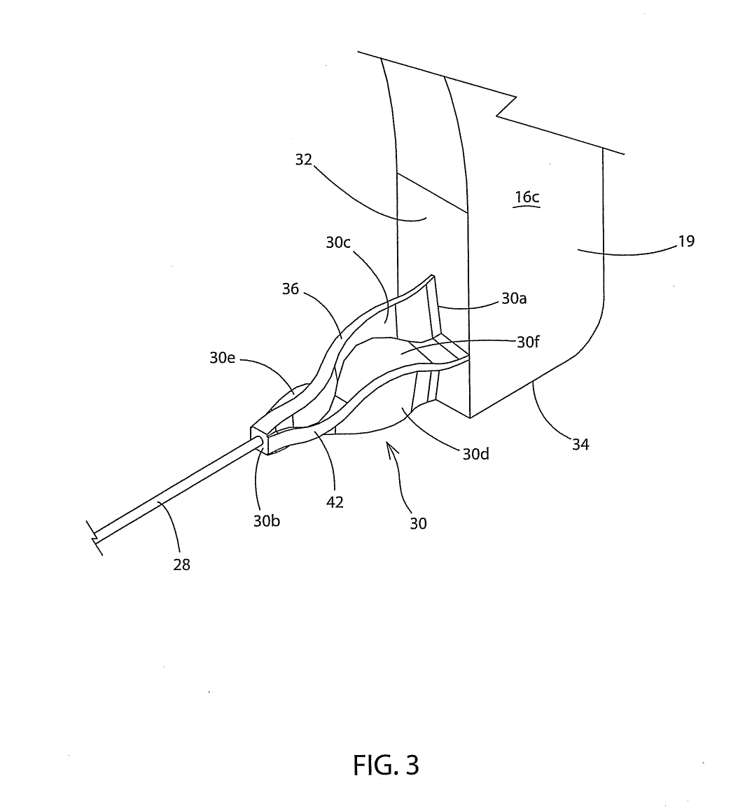

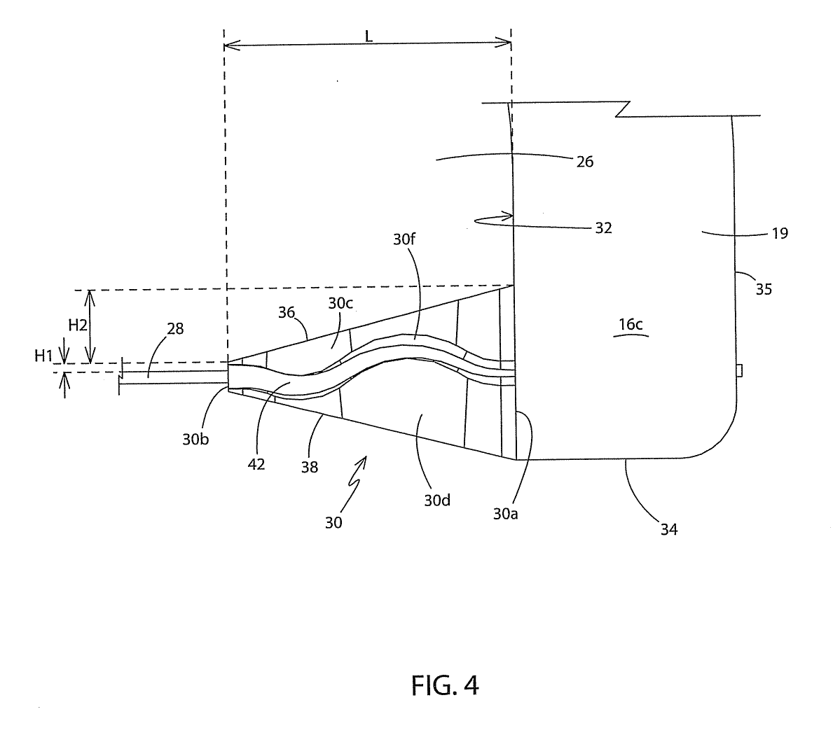

In accordance with yet another specific feature of the present invention and referring to FIGS. 3 and 4, toothpick member 30 is generally arrowhead-shaped and extends outwardly from interior surface 32 of second arm 16c. Toothpick member 30 has a first end 30a (FIG. 4) adjacent interior surface 32 and a second end 30b disposed a spaced distance from interior surface 32. Preferably, toothpick member 30 tapers from first end 30a to second end 30b thereof. Toothpick member 30 may comprise a separate component that is secured to interior surface 32 or it may be integrally formed therewith. The longitudinal axis of toothpick member 30 extends between first and second ends 30a, 30b and preferably is substantially at right angles to interior surface 32. Second end 30b may be flattened and generally parallel to interior surface 32.

At least one blade is provided on toothpick member 30 extending radially outwardly from the longitudinal axis thereof. Preferably, four blades are provided on toothpick member 30, namely first blade 30c, second blade 30d, third blade 30e and fourth blade 30f. Each blade 30c-30f extends radially outwardly away from the longitudinal axis of toothpick member 30 and generally at right angles thereto. Furthermore, each blade 30c-30f extends rearwardly from second end 30b of toothpick member 30 and terminates at first end 30a thereof. First and second blades 30c, 30d are generally vertically oriented and third and fourth blades 30e, 30f are generally horizontally oriented. Consequently, each blade is disposed generally at ninety degrees relative to the adjacent blades and blades 30c-30f intersect each other along their bases (unnumbered). It will be understood that toothpick member 30 may include more than four blades or less than four blades without departing from the scope of the invention and that these blades may be disposed at angles other than ninety degrees relative to each other.

Each blade 30c-30f has a first side wall and a second side wall that are opposed to each other and extend from first end 30a to second end 30b of toothpick member 30. The first side wall and second side wall are numbered 52 and 54, respectively, for each of first and second blades 30c, 30d. First side wall and second side wall are numbered 56 and 58, respectively, for third and fourth blades 30e, 30f. First blade 30c extends upwardly and outwardly away from first sides walls 56 of third and fourth blades 30e, 30f. Second blade 30d extends downwardly and outwardly away from second side walls 58 of third and fourth blades 30e, 30f. Third blade 30e extends horizontally outwardly away from a first side wall 52 of each of the first and second blades 30c, 30d. Fourth blade 30f extends horizontally outwardly away from a second side wall 54 of each of the first and second blades 30c, 30d.

Each blade 30c-30f further includes a base (unnumbered) disposed proximate or in abutting contact with the two adjacent blades and has an outermost wall remote therefrom. The base and outermost wall extend between the first and second side walls thereof and extend between first end 30a and second end 30b of toothpick member 30. The outermost walls of blades 30c-30f are numbered 36, 38, 40 and 42 respectively. Each of the outermost walls 36-42 is disposed generally at right angles relative to the two adjacent outermost walls.

First and second blades 30c, 30d are disposed substantially at 180 degrees relative to each other, are substantially identical in shape and are mirror images of each other. Similarly, third and fourth blade 30e, 30f are disposed substantially at 180 degrees to each other, are substantially identical in shape and are mirror images of each other.

As can best be seen in FIG. 6, toothpick member 30 has a generally undulating X-shape when viewed from second end 30b and toward interior surface 32. In accordance with another specific feature of the present invention, all four of the blades 30c-30f are sinuous along their lengths “L” (FIG. 4) as measured between second end 30b and interior surface 32. Each of first, second, third and fourth blades 30c-30f taper in height along their lengths from interior surface 32 to second end 30b. Consequently, each of first, second, third and fourth blades 30c-30f are of the shortest height “H1” (FIG. 4) adjacent second end 30b and of the greatest height “H2” adjacent interior surface 32. Only the heights H1 and H2 of first blade 30c are shown on FIG. 4 for the sake of clarity but it will be understood that second, third, and fourth blades 30d, 30e and 30f are similarly shaped.

The width of first blade 30c as measured from first side wall 52 to second side wall 54 thereof preferably remains substantially constant for substantially the entire length of first blade 30c. This is true for each of second, third and fourth blades 30d-30f as well. Each of the outermost walls 36-42 of blades 30c-30f are generally flattened along their lengths. Each of the outermost walls 36-42 has longitudinal edges that extend from second end 30b to interior surface 32. For the sake of clarity, only the edges of outermost wall 36 of first blade 30c are numbered on FIG. 6 as edges 36a and 36b. The width of the outermost walls 36, 38, 40, and 42 as measured between the edges 36a, 36b, for example, preferably taper from adjacent second end 30b to adjacent interior surface 32. Preferably, outermost wall 38 of second blade 30d is substantially continuous with outermost end 34 of second arm 16c.

The heights and widths of the four blades and the widths of the outermost walls may all be substantially identical or the first and second blades 30c, 30d may be substantially equal to each other and the third and fourth blades 30e, 30f may be substantially equal to each other but different from the first and second blades. The taper on the first, second, third and fourth blades permits the blades to deform more easily and thereby allows toothpick member 30 to more deeply penetrate into an interproximal space 46 (FIG. 7a) as will be hereinafter described.

As indicated previously, floss 28 extends between first arm 16b and second arm 16c. Specifically, floss 28 extends between the interior surface 33 (FIG. 2) of first arm 16b and second end 30b of toothpick member 30. Floss 28 may be integrally formed with first arm 16b and toothpick member 30 or it may be secured in some suitable manner to each of first arm 16b and toothpick member 30. The longitudinal axis of toothpick member 30 is aligned with the longitudinal axis “Y” of floss 28.

It will further be understood that the toothpick member may be located on interior surface 33 of first arm 16b instead of on second arm 16c. Additionally, a toothpick member may be located on the interior surfaces 33. 32 of each of the first and second arms 16b, 16c and the length of floss 28 extend between the second ends of the two opposed toothpick members.

Referring to FIGS. 7a and 7b, the device of the present invention is used in the following manner. The user grasps handle 14 of floss pick 10 between the thumb and index finger of their hand 44. They position floss pick 10 so that floss 28 slides into interproximal space 46 between a first tooth 48 and a second tooth 50. In order to floss the teeth 48, 50, floss pick 10 is manipulated by making small movements back-and-forth as indicated by arrow “A”, up-and-down as indicated by arrow “B” and side-to-side to remove plaque and debris from portions of the front and rear surfaces of teeth 48, 50.

In order to use toothpick member 30, floss pick 10 is moved in the direction of arrow “C” (FIG. 7b) so that floss 28 guides second end 30b of toothpick member 30 into interproximal space 46 as floss 28 is already positioned therein. Floss pick 10 is then moved up-and-down, side-to-side and in-and out and necessary to remove trapped debris or plaque from the surfaces of teeth 48, 50 from space 46. Once finished, the user moves floss pick upwardly so as to slide floss 28 and/or toothpick member 30 out of interproximal space 46. Floss pick 10 is then moved laterally to engage floss 28 in the next adjacent interproximal space. When the user is finished, floss pick 10 is thrown away.

The overall configuration of toothpick member 30 has been found to result in an effective tool for removing plaque from interproximal spaces between teeth. The combination of the sinuous, tapered and flattened surfaces of toothpick member 30, along with edges, such as 36a and 36b (FIG. 6) of the outermost walls 36-42, all aid in toothpick member 30 being effective to scrub plaque and debris from the teeth.

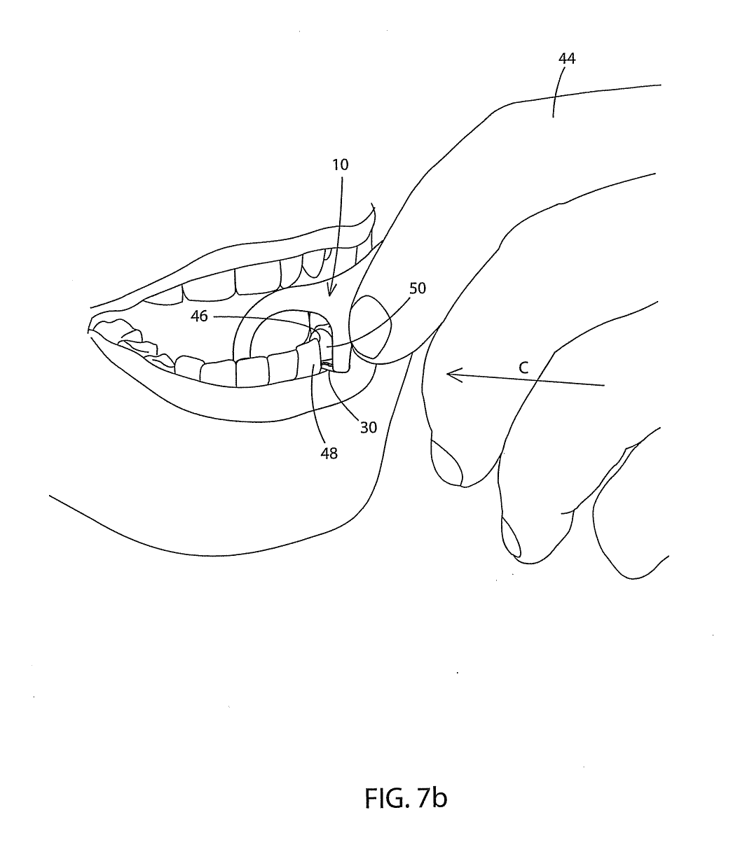

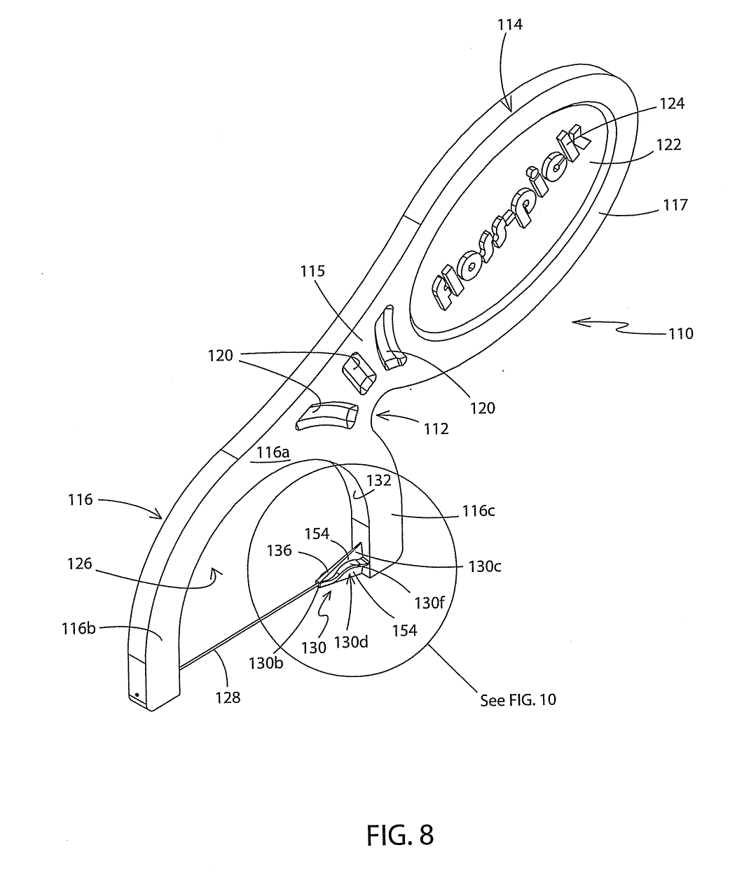

Referring to FIGS. 8-13 there is shown a second embodiment of a floss pick in accordance with the present invention indicated generally at 110. Floss pick 110 comprises a body 112 including a handle 114 and a head 116. Head 116 preferably is disposed at an angle relative to handle 114 and body 112 is generally F-shaped. Handle 114 extends outwardly from a rear end of head 116 and includes a neck 115 and a generally oval lobe 117. Neck 115 preferably defines one or more cavities 120. Lobe 117 defines a recessed region 122 on each of the front and rear surfaces of handle 114. Indicia 124 may be applied to the interior wall of recessed region 122. As with the previous embodiment, only the recessed region 122 on the front surface of handle 114 is illustrated in the attached figures but a substantially identical recessed region 122 is provided in the rear surface. Lobe 117 and recessed regions 122 therein preferably are sized so that the pad of a user's thumb is received in one of recessed regions 122 and the pad of the user's index finger is received in the other of the recessed regions 122. In accordance with one of the specific features of the present invention and as shown in FIG. 9, the oval shape of lobe 117 and the width of the handle 114 as measured between the front and rear surfaces thereof, enable the user to more readily and easily grip floss pick 110 than was the case with previously known devices.

As with the first embodiment, head 116 preferably is generally U-shaped and includes a central region 116a, a first arm 116b and a second arm 116c. Central region 116a, and first and second arms 116b, 116c define a C-shaped cavity 126. At least one length of floss 128 extends between first and second arms 116b, 116c. In accordance with a specific feature of the present invention, however, a second embodiment of a toothpick member 130 is disposed on body 112. Toothpick member 130 specifically is provided on head 116 and not on the handle 114 as was the case with previously known floss picks. Toothpick member 130 is provided on one of first and second arms 116b, 116c and preferably is integrally formed with and extends outwardly from an interior surface 132 of second arm 116c and into cavity 126.

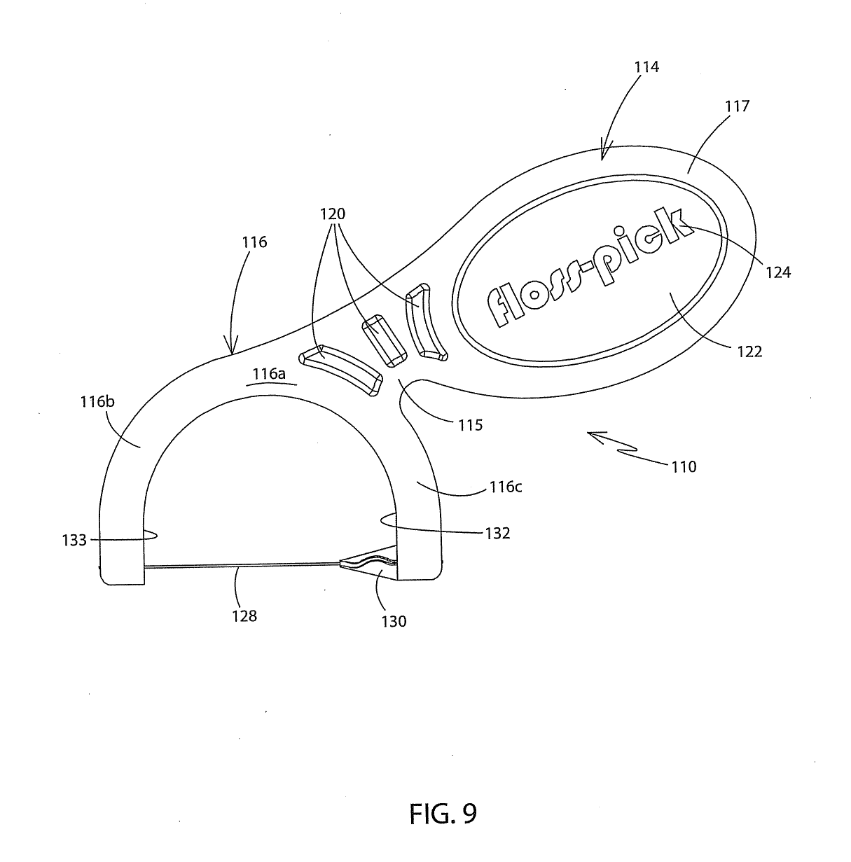

Toothpick member 130 is shown in greater detail in FIGS. 10-13. Toothpick member 130 includes a second end 130b spaced a distance away from interior surface 132 of second arm 116c. Preferably, second end 130b is generally parallel to interior surface 132. Four blades extend outwardly and rearwardly from second end 130b and toward interior surface 132, namely, first blade 130c, second blade 130d, third blade 130e and fourth blade 130f. First and second blades 130c, 130d are generally vertically oriented and third and fourth blades 130e, 130f are generally horizontally oriented. First blade 130c extends upwardly and outwardly away from upper surfaces of third and fourth blades 130e, 130f. Second blade 130d extends downwardly and outwardly away from lower surfaces of third and fourth blades 130e, 130f. Third blade 130e extends horizontally outwardly away from a left side wall of each of the first and second blades 130c, 130d. Fourth blade 130f extends horizontally outwardly away from a right side wall of each of the first and second blades 130c, 130d.

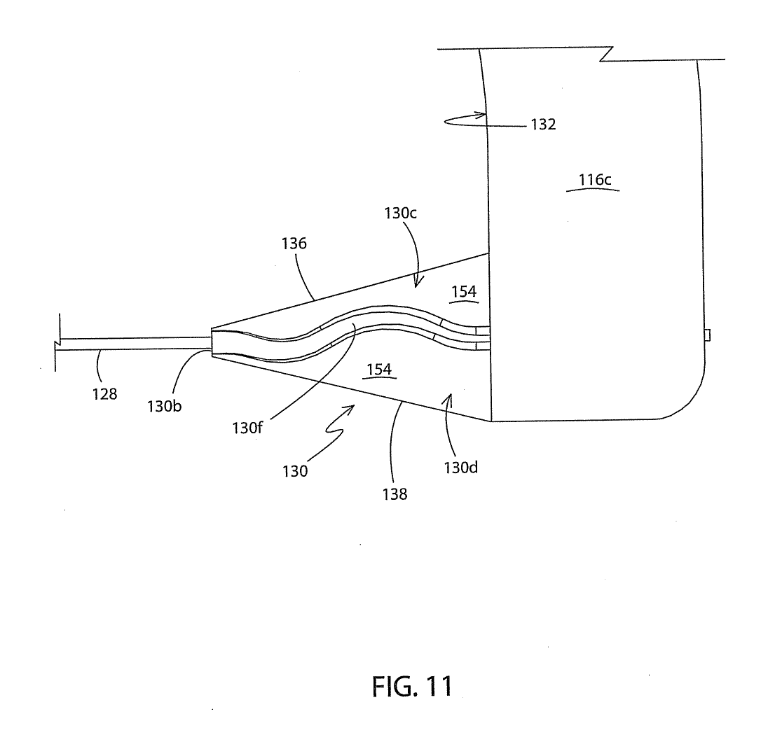

In accordance with the present invention and as can best be seen in FIG. 13, toothpick member 130 is generally X-shaped when viewed from second end 130b and toward interior surface 132. First and second blades 130c, 130d are substantially identical to each other and third and fourth blades 130e, 130f are substantially identical to each other. In accordance with a specific feature of the present invention, first and second blades 130c, 130d are generally a truncated-triangle in cross-sectional shape. Each of first and second blades 130c, 130d has generally planar and straight first and second side walls 152, 154 and has generally planar and straight outermost walls 136, 138, respectively. The term “straight” as used herein indicates that the blade or outermost wall is substantially free of curves. Each of first and second blades 130c, 130d taper in width from their bases adjacent the third and fourth blades 130e, 130f to adjacent their outermost walls 136, 138. Additionally, first and second blades 130, 130d taper in height from adjacent interior surface 132 to adjacent second end 130b. Additionally, the width of each outermost wall 136, 138 tapers from adjacent second end 130b to adjacent interior surface 132. This is seen in FIG. 12. Preferably, outermost wall 138 of second blade 130d is substantially continuous with outermost end 134 of second arm 116c.

In accordance with yet another feature of the present invention, third and fourth blades 130e, 130f are sinuous along their lengths between second end 130b and interior surface 132. Each of the third and fourth blades 30e, 30f has a generally flattened outermost wall with the outermost wall of third blade 130e being indicated at 140 and the outermost wall of fourth blade 130f being indicated at 142. Third and fourth blades 130e, 130f are substantially identical to third and fourth blades 30e, 30f and therefore won't be described in any additional detail herein.

It will be understood that instead of first and second blades 30c, 30d walls being generally planar along their lengths and third and fourth blades 30e, 30f being generally sinuous, first and second blades may be sinuous and third and fourth blades may be substantially planar, without departing from the spirit of the present invention.

Floss 128 extends between first arm 116b and second arm 116c. Specifically, floss 128 extends between the interior surface 133 (FIG. 9) of first arm 116b and second end 130b of toothpick member 130. Floss 128 may be integrally formed with first arm 116b and toothpick member 130 or it may be secured in some suitable manner to each of first arm 116b and toothpick member 130. Floss pick 110 is used in substantially the same manner as floss pick 10.

Referring to FIGS. 14 and 15 there is shown a third embodiment of a toothpick member indicated generally at 230. Toothpick member 230 extends outwardly from an interior surface 232 of a second arm 216c of a floss pick 210. Floss pick 210 may be either one of floss picks 10 and 110 or any other type of floss pick. As with the previous embodiments, a length of floss 228 extends between a first arm (not shown) of floss pick 210 and a second end 230b of toothpick member 230. FIG. 15 shows that toothpick member 230 includes first, second, third and fourth blades 230c, 230d, 230e and 230f. First and second blades 230c, 230d are substantially identical to first and second blades 130c and 130d respectively. Consequently, each of first and second blades 230c, 230d has substantially planar and straight first and second side walls 252, 254 that extend rearwardly from second end 230b to interior surface 232. Each of first and second blades 230c, 230d taper in width from where they extend outwardly from third and fourth blades 230e, 230f to their outermost walls 236, 238. First and second blades 230c, 230d also taper in height along their length from adjacent interior surface 232 to adjacent second end 230b. Thus, the height of first and second blades 230c, 230d is smaller adjacent second end 230b than adjacent interior surface 232. Finally, outermost walls 236, 238 are tapered in width, being wider adjacent second end 230b and narrower adjacent interior surface 232.

In accordance with a specific feature of this embodiment of the invention, third and fourth blades are substantially identical in shape to the first and second blades 230c, 230d and have planar and straight side walls 256, 258 and are generally a truncated-triangle in cross-sectional shape. Consequently, none of first, second, third or fourth blades 230c-230f are sinuous in nature along their lengths. Third and fourth blades 230e, 230f taper in width and height in the same way as first and second blades 230c, 203d and outermost walls 240, 242 taper in width in the same way as outermost wall 236, 238. Toothpick member 230 is used in substantially the same way as toothpick member 30.

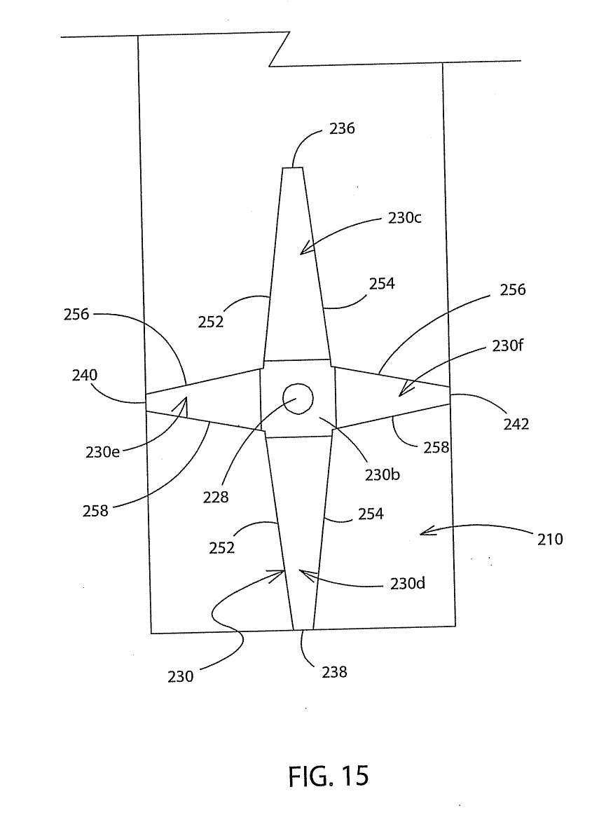

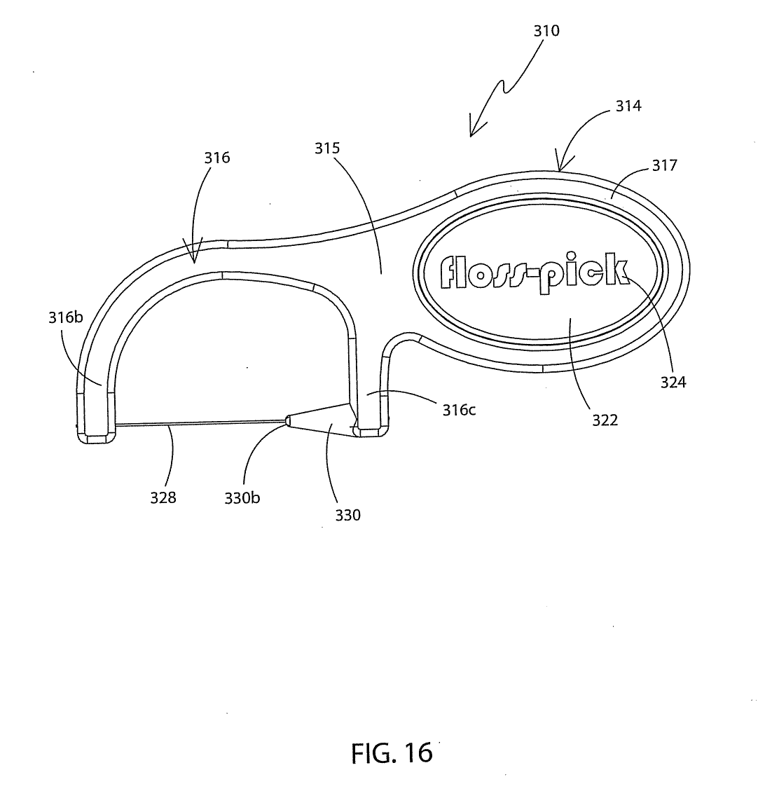

Referring to FIGS. 16-18, there is shown a fourth embodiment of a floss pick in accordance with the present invention and indicated generally at 310. Floss pick 310 includes a handle 314 and head 316 and is generally F-shaped. Handle 314 comprises a neck 315 that is free of cavities and a lobe 317 that is generally oval in shape. Lobe 317 defines an oval recessed region 322 in each of the front and rear surfaces of handle 314 and recessed regions 322 may include indicia 324 therein. As with recessed regions 122 of floss pick 110, recessed regions 322 are configured to receive the pads of the user's thumb and index finger therein for easier gripping by a user. A comparison between floss pick 110 and 310 shows that lobe 317 is substantially more aligned longitudinally with head 316 than lobe 117 is with head 116. Lobe 117 and head 116 are disposed at more of an angle to each other and less in alignment with each other. The orientation of lobe 317 and head 316 has been found to be an effective configuration for both flossing and using toothpick member 330. In accordance with one of the specific features of the present invention and as shown in FIG. 17, the oval lobe 317 of handle 314 is generally equivalent in length L1 to the length L2 of head 316. Additionally, the oval shape of handle 314 and the width thereof as measured between the front and rear surfaces thereof, enable the user to more readily and easily grip floss pick 310 than was the case with previously known devices.

As with previous embodiments, toothpick member 330 is provided on head 316 and extends outwardly from second arm 316c. A length of floss 328 extends between first arm 316b and a second end 330b of toothpick member 330. Floss pick 310 is shown in cross-section in FIG. 17. As is evident from this figure, preferably all of head 316, neck 315, lobe 317 and toothpick member 330 are integrally formed, such as by injection molding. Toothpick member 330 defines an interior bore 361 that extends between the first end 330a and second end 330b thereof and generally along the longitudinal axis of toothpick member 330. Furthermore, one or both of first and second arms 316b, 316c defines a slot 363 therein. Slot 363 is in communication with bore 361 and is generally aligned therewith. At least a first portion of floss 328 is received through bore 361 and a second portion of floss 328 is received through slot 363. If slots 363 are provided in both of first and second arms 316b, 316c, then a portion of floss 328 is received in each of slots 363. Preferably, the ends of floss 328 are embedded within slots 363 of first and second arms 316b, 316c and extend through the interior bore 361 of toothpick member 330. (It should be noted that all of picks 10, 110, and 210 may be manufactured in this manner).

In accordance with a specific feature of the present invention, toothpick member 330 is provided with a sheath 360 that envelops the blades thereof. Toothpick member 330 may be configured as any one of toothpick members 30, 130 and 230. Sheath 360 preferably is made from an elastomeric material such as rubber so that it exhibits resiliency and is at the same time gentle on the user's gums. The combination of the inner X-shaped blade configuration of toothpick member 330 and the external sheath 360 make for a sturdy and functional dental stimulator. Because of the presence of sheath 360 over a portion of second end 330b, that region of toothpick member 330 is effectively rounded and floss 328 extends outwardly through an aperture in this rounded end. Floss pick 310 is used in substantially the same manner as floss pick 10. Because of the presence of shield 360 on toothpick member 330, toothpick member 330 is not only able to be used to remove plaque and debris from interproximal spaces between surfaces of adjoining teeth but is also able to massage the gum tissue surrounding at least portions of those surfaces and thereby improve the oral health of the user.

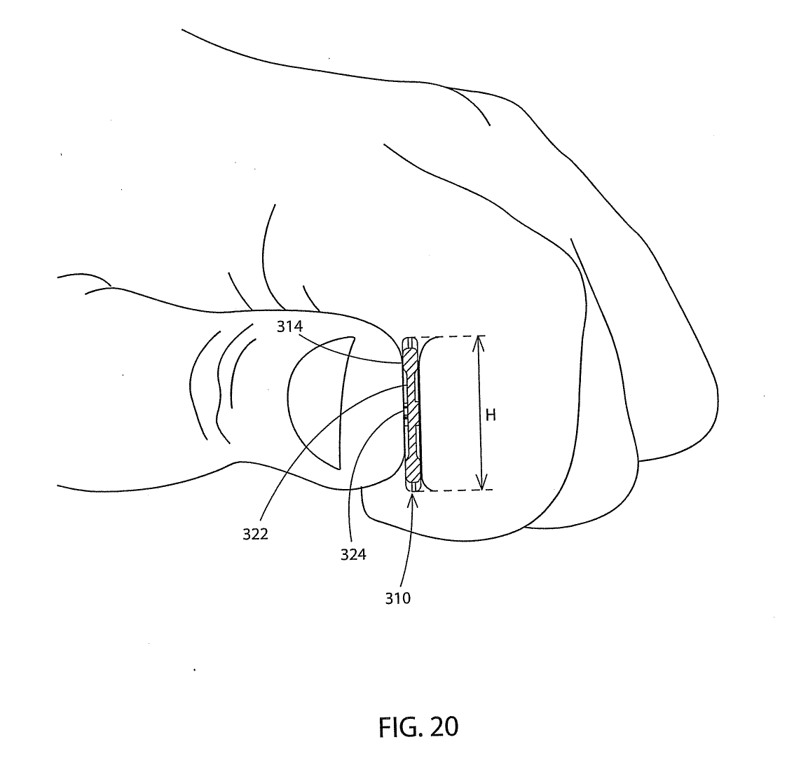

Referring to FIGS. 21-23b there is shown a fifth embodiment of a floss pick in accordance with the present invention and generally indicated at 410. Floss pick 410 includes a body 412 comprising a handle 414 and a head 416. In accordance with one of the specific features of this embodiment, handle 414 includes a preferably oval lobe 417 that is secured to head 416 by a neck 415. Lobe 417 includes a preferably oval recessed region 422 on each of the front and rear surfaces of handle 414. Recessed regions 422 are configured to receive the pads of the user's thumb and index finger so that pick 410 is more easily and securely gripped than previously known devices.

In accordance with yet another specific feature of the invention, head 416 includes a length of floss 428 therein that extends between first and second arms 416b, 416c. Unlike the previous embodiments, however, a toothpick member is not provided on the head 416 extending inwardly from one of the first and second arms 416b, 416c and secured in longitudinal alignment with floss 428. Instead, toothpick member 470 is integrally formed in handle 414. Specifically, toothpick member 470 is formed in the recessed regions 422 of lobe 417 of handle 414. Toothpick member 470 comprises a generally V-shaped region 472 that is defined by a V-shaped aperture 474 in recessed region 422. A tab 476 is defined on a portion of perimeter 417a of lobe 417 and a pair of slots 478, 480 separate tab 476 from the rest of the perimeter 417a. A bridge member 482 extends between slot 478 and aperture 474 and a second bridge member 484 extends between slot 480 and aperture 474. It should be understood that what is meant by the term “V-shaped” is that this region is generally triangular in shape and is a component that is shaped so that it is wider at one end and tapers toward the other end, terminating in a narrowed or pointed apex or tip.

It should be noted that the apex 472a of the V-shaped region 472 is disposed inwardly from the tab 476 and perimeter 417a of handle 414. Furthermore, the base region 472b of the V-shaped region 472 is disposed proximate tab 476 and perimeter 417a. V-shaped region 472 is integrally formed as part of the interior wall 422a of recessed region 422. Consequently, a front surface of V-shaped region 472 is coplanar with a front surface of interior wall 422a and a rear surface of V-shaped region 472 is coplanar with a rear surface of interior wall 422a. Additionally, it should be noted that V-shaped region 472 is positioned so that it effectively points toward head 416. Thus, when the user grasps handle 414, toothpick member 470 is shielded and will not prick or otherwise injure the user's hand.

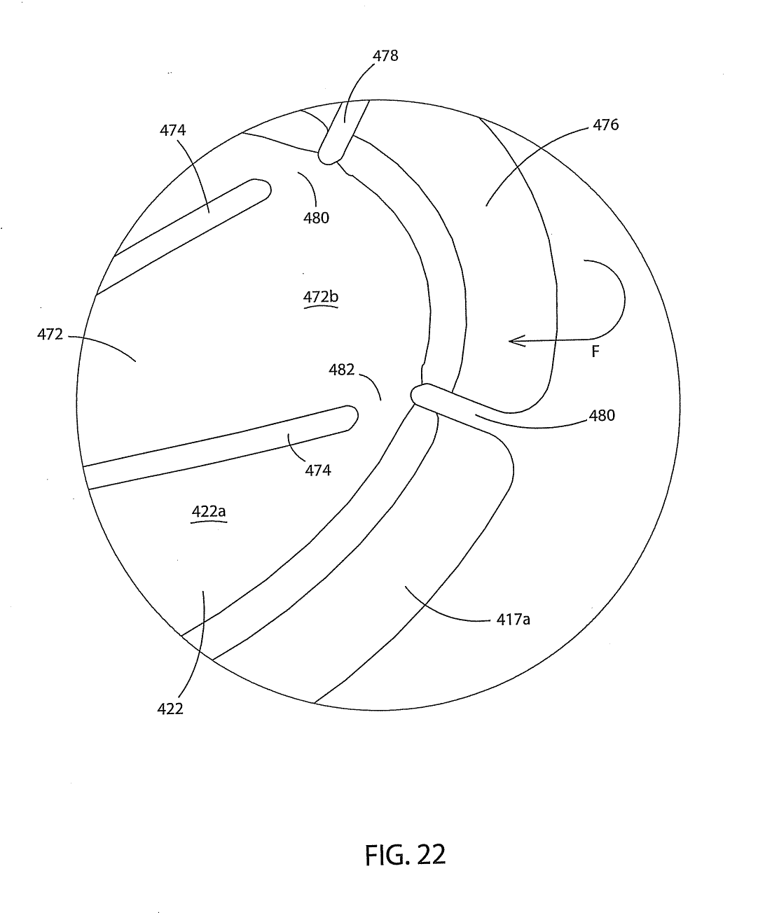

Referring to FIG. 23a, 23b, floss pick 410 is used by grasping handle 414 between the thumb and index finger. As indicated previously, when the user grips floss pick 410, the pads of the thumb and index finger are seated within the recessed regions 422 on oval lobe 417. Floss pick 410 is used in the manner to floss teeth as all the previous embodiments of the floss pick. The length of floss 428 is inserted into an interproximal space 426 between two adjoining teeth 448, 450 and floss pick 410 is moved back-and-forth, up-and-down and from side-to-side to remove plaque and debris from interproximal space 446. If a particularly stubborn region of plaque or a piece of debris is lodged in interproximal space 446, the user will disengage floss 428 of floss pick 410 from space 446. Using their other hand, the user will pull tab 476 in the direction indicated by arrow “F”. This movement causes the bridge members 478, 480 to be torn so that slot 478 becomes continuous with one end of aperture 474 and slot 480 becomes continuous with the other end of aperture 474. When this occurs, toothpick member 470 including tab 476 becomes separated from handle 417. Toothpick member 470 may then be independently used, in the manner indicated in FIG. 23a, to remove the stubborn plaque or debris from interproximal space 446. Thus, the apex 472a of V-shaped region 472 will be inserted into interproximal space 446 and toothpick member 470 will be manipulated until the plaque or debris is dislodged. It should be noted that even though V-shaped region 472 and tab 476 have been removed therefrom, handle 414 is still easily grasped by the user to continue flossing of the teeth.

Although not specifically shown in the attached drawings, it will be understood that a toothpick member in accordance with the teachings of this description may be provided on any type of floss pick. In other words, the toothpick member could be included on floss picks that include a dispensed length of floss or where a length of floss is secured to the pick by the user. Furthermore, it should be understood that the length of floss does not have to originate in the toothpick member. Instead, the length of floss could be secured between the first and second arms of the floss pick inwardly of the free ends of those arms and the toothpick member could be provided between the length of floss and the free end of one arm.

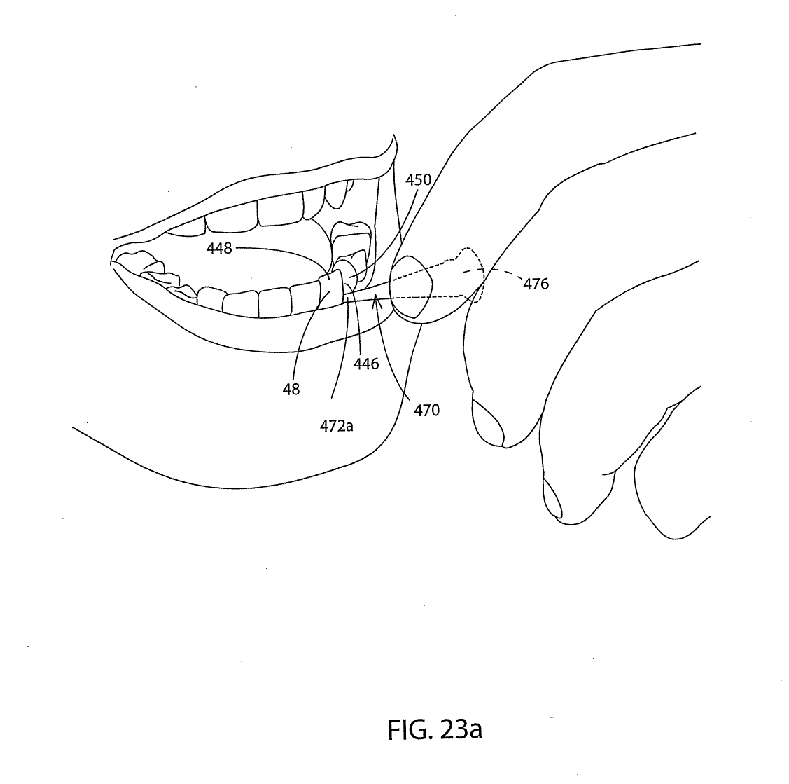

Referring to FIGS. 24-32 there is shown a sixth embodiment of a floss pick in accordance with the present invention, generally indicated at 510. Floss pick 510 includes a body 512 comprising a handle 514 and a head 516. In accordance with one of the specific features of this embodiment, handle 514 includes a preferably oval lobe 517 that is secured to head 516 by a neck 515. Lobe 517 includes a preferably oval recessed region 522 on each of the front and rear surfaces of handle 514. Recessed regions 522 are configured to receive the pads of the user's thumb and index finger therein so that pick 510 is more easily and securely gripped than was possible in previously known devices. Head 516 includes a length of floss 528 therein that extends between first and second arms 516b, 516c.

In accordance with yet another specific feature of the invention, pick 510 is provided with a toothpick member 570 that is substantially similar to toothpick member 470 except that it is not designed to be detachable from body 512 but is instead pivotable relative thereto. Toothpick member 570 is integrally formed with handle 514 as is toothpick member 470. Specifically, toothpick member 570 is positioned in aperture 574 defined in recessed regions 522 of lobe 517 of handle 514.

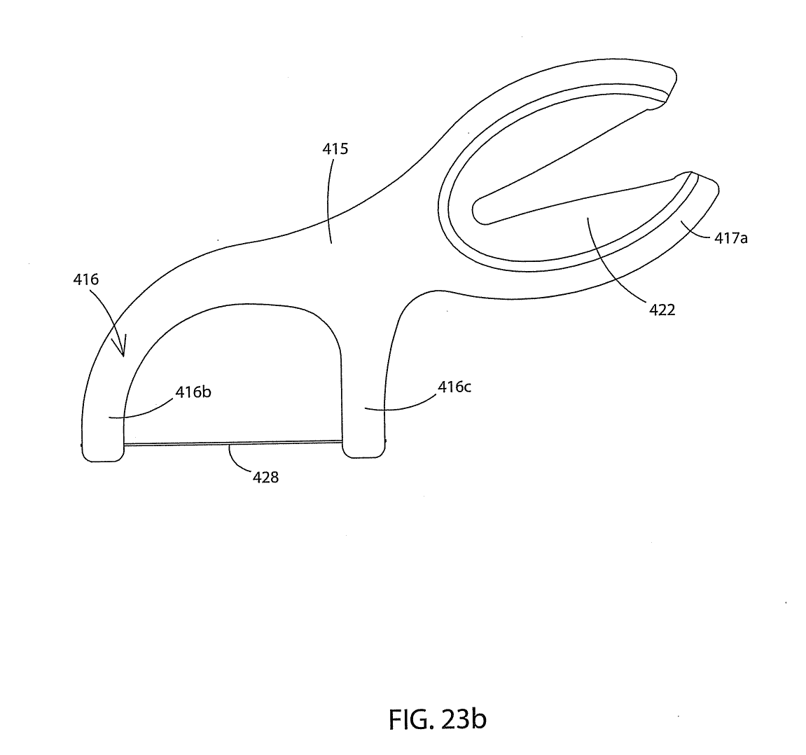

Toothpick member 570 includes a first region 572 and a second region 576. First region 572 is generally V-shaped first region 572 and is disposed within a generally V-shaped area of aperture 574 (FIG. 25). Second region 576 comprises a portion of the perimeter 517a of body 512 when toothpick member 570 is in a non-use first position, i.e., when it is aligned with the longitudinal axis “Y” of body 512 and is generally coplanar with a front surface 522a of recessed region 522. It should be understood that toothpick member 570 has a longitudinal axis that is coaxial with the longitudinal axis “Y” of body 512 when toothpick member 570 is in this first position. Second region 576 and first region 572 are connected to each other at a transition zone. Second region 576 constitutes a tab that extends to an outermost edge of perimeter 517a and is engageable to pivot toothpick member 570 as will be described hereinafter. A pair of slots 578, 580 separate second region 576 from the rest of the perimeter 517a.

In accordance with a specific feature of the present invention, a first bridge member 582 extends from a portion of handle 214 to toothpick member 570 and is disposed between slot 578 and aperture 574. A second bridge member extends from a portion of handle 214 to toothpick member 570 and is disposed between slot 580 and aperture 574. First and second bridge members 582, 584 are of substantially the same thickness as recessed region 522 of body 512. First and second bridge members 582, 584 are spaced a distance from each other, extend toward each other, and are aligned with each other. A pivot axis “X” (FIG. 24a) extends through first and second bridge members 582, 584 and toothpick member 570 is able to pivot about pivot axis “X”. Preferably, this pivot axis “X” is disposed substantially at right angles to the longitudinal axis “Y” of body 512 so that when toothpick member 570 pivots about the pivot axis “X”, it travels in a plane that is disposed substantially at right angles to the longitudinal axis of the body.

When toothpick member 570 pivots from the first position to a second position (as will be hereinafter described), each of the first and second bridge members 582, 584 is twisted about pivot axis “X”. As shown in FIG. 25b, second bridge member 584 is thereby caused to assume a spiral shape. It should be noted that first and second bridge members 582, 584 twist in opposite directions to each other as toothpick member 570 pivots. Consequently, first bridge member 582 is twisted into a spiral shape that is a mirror image of that illustrated in FIG. 25b.

First and second bridge members 582, 584 are dimensioned so that they are able to be twisted yet remain unbroken when toothpick member 570 pivots. Specifically, first and second bridge members 582, 584 are sufficiently long enough and strong enough to twist through about 180 degrees without shearing or fracturing as toothpick member pivots. Bridge members 582, 584 connect toothpick member 570 to a portion of handle 514 that defines aperture 574. A first end of each of the first and second bridge members 582,584 is secured to toothpick member 570. A second end of each of the first and second bridge members 582, 584 is secured to a portion of handle 514. Specifically, first and second bridge members 582, 584 are connected to toothpick member 570 at a transition zone between first region 572 and second region 576. The transition zone is essentially located proximate the base 572b of first region 572. Consequently, first and second bridge members 582, 584 are spaced a distance inwardly from the outermost edge of perimeter 517a and portions of handle 514 extend beyond the first and second bridge members 582, 584. Second region 576 is therefore located in a position where it can be easily engaged using an index finger and can be moved in one of a first direction and a second direction to cause toothpick member 570 to pivot about the pivot axis “X” extending through first and second bridge members 582, 584. As illustrated in FIG. 25a, first and second bridge members 582, 584 become twisted when toothpick member 570 is pivoted from a non-use position (shown in FIGS. 24a & 24b) to a use position (shown in FIG. 25.)

In accordance with yet another feature of the present invention, first region 572 of toothpick member 570 is disposed within recessed region 522 and is generally as thick as recessed region 522. Thickness is measured between the front face 512a and rear face 512b of body 512. Second region 576 of toothpick member 570 is substantially as thick as perimeter 517a of lobe 517. Consequently, second region 576 of toothpick member 570 is thicker than first region 572 thereof. This makes second region 576 more rigid than first region 572 and makes it easier to contact and manipulate using the index finger of the hand in which floss pick 510 is held as will be described hereafter. Additionally, a front surface of first region 572 is coplanar with a front surface of interior wall 522a and a rear surface of first region 572 is coplanar with a rear surface of interior wall 522a. Additionally, it should be noted that the V-shaped first region 572 is positioned so that it effectively points toward head 516 before use, i.e., the apex or tip 572a thereof is disposed closer to head 516 than is the base 572b thereof. Thus, when the user grasps handle 514 to position floss 528 between the user's teeth, apex 572a of toothpick member 570 is shielded and will not prick or otherwise injure the user's hand.

In accordance with a specific feature of the present invention, aperture 574 defined in recessed region 522 includes two distinct areas. The first area 574a is generally V-shaped and extends from an apex in the interior of recessed region 522 outwardly to adjacent the outermost edge of perimeter 517a. The second area includes first and second arcuate areas 575a, 575. Each of the arcuate areas cuts into that portion of the recessed region 522 that flanks the transitional zone of toothpick member 570 when disposed in the non-use position. The width “W” of this second area in recessed region 522 as measured from the inner edge of first arcuate area 575a to the inner edge of second arcuate area 575b is substantially the same as the width of second region 576 of toothpick member 570 for reasons that will be explained later herein.

As indicated previously, toothpick member 570 is not detachable from floss pick 510 as was toothpick member 470. Instead, toothpick member 570 remains permanently attached to handle 514 by way of first and second bridge members 582 and 584. Toothpick member 570 is able to pivot or swivel relative to handle 514. More particularly, toothpick member 570 is able to pivot through almost 360 degrees relative to handle 514 in that it is able to pivot through about 180 degrees in a first direction or about 180 degrees in an opposite second direction.

Floss pick 510 is used by grasping handle 514 between the thumb and index finger of one hand. When the user grips floss pick 510, the pads of the user's thumb and index finger are at least partially seated within the recessed regions 522 on either side of oval lobe 517. Floss pick 510 is used in substantially the manner to floss teeth as all the previous embodiments. The length of floss 528 is inserted into an interproximal space between two adjoining teeth and is moved back-and-forth, up-and-down and from side-to-side to remove plaque and debris from the interproximal space.

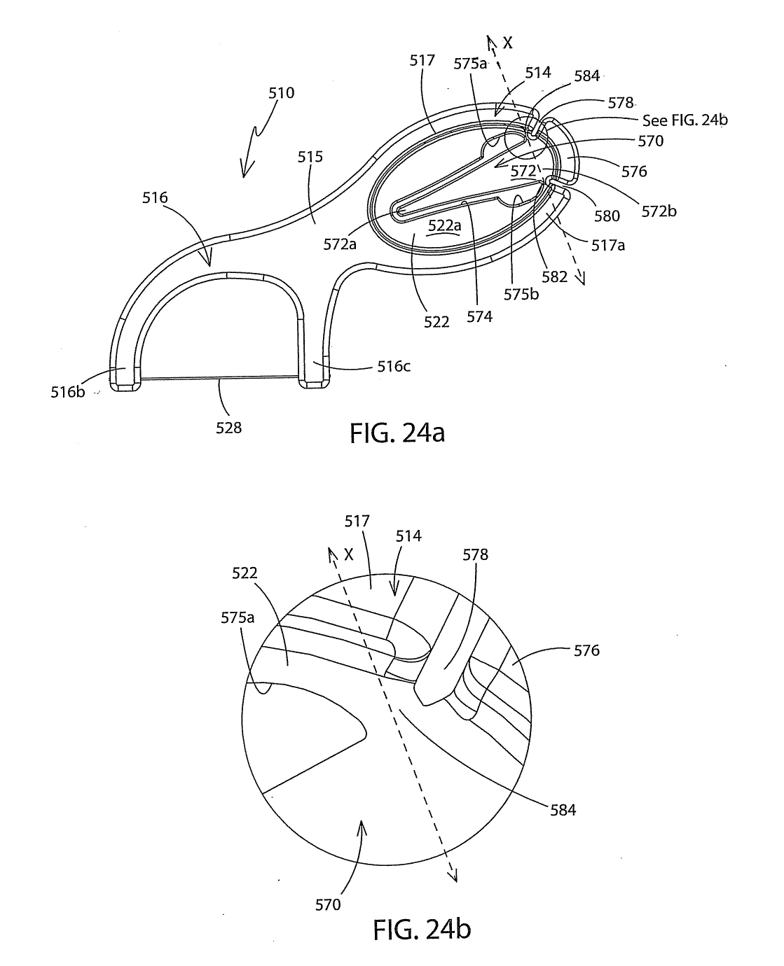

If a particularly stubborn region of plaque or a piece of debris is lodged in the interproximal space, the user will disengage floss 528 of floss pick 510 from the space. The user will rotate the floss pick through 180 degrees so that they are holding the head 516 in one hand. At this stage, toothpick member 570 is in the first position where its longitudinal axis is coaxial with longitudinal axis “Y” of body 512 and toothpick member 570 is aligned with body 512. The user will then engage second region 576 of toothpick member 570 with a portion of their index finger and will either push or pull second region 576 to cause toothpick member 570 to pivot about the pivot axis “X” that extends through first and second bridge members 582, 584 to move toothpick member 570 to a second position. For example, if the user is holding body 512 in their right hand, the user may pull second region 576 in a direction indicated by arrow “G” in FIG. 26. This engagement will cause second region 576 to pivot about first and second bridge members 580, 582 and thereby move first region 572 out of alignment with body 512 of floss pick 510. First and second bridge members 580, 582 will twist as toothpick member 570 is pivoted. The user will continue to pull on second region 576 until first region 572 is retained at a suitable angle relative to front surface 512a of body 512. The user will keep their index finger in contact with second region 576 or toothpick member 570 will tend to move around during picking or will pivot back to its original position.

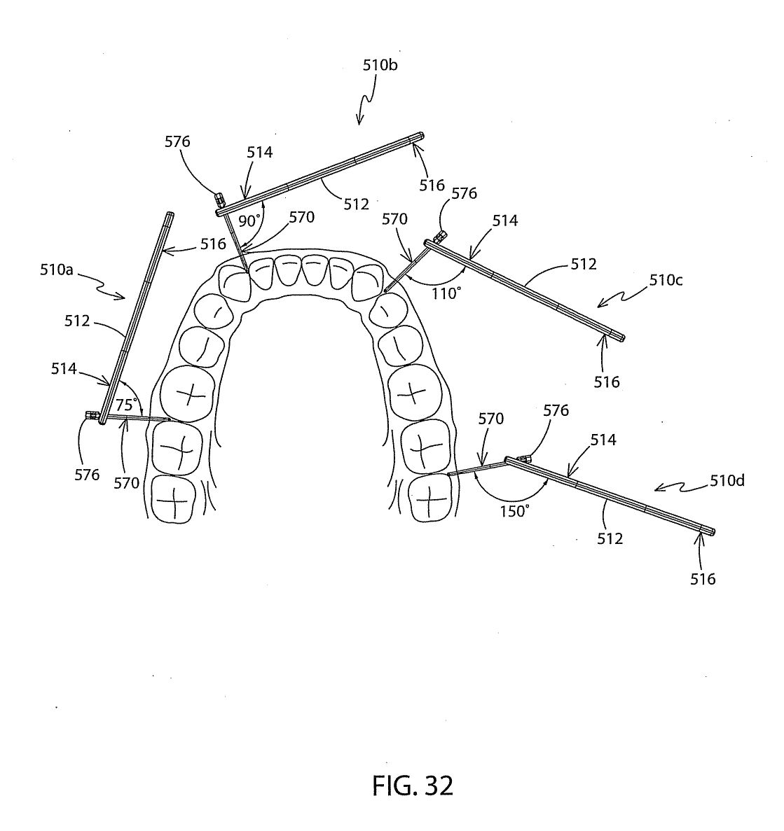

In a first instance, as illustrated in FIG. 26, second region 576 is moved in such a direction that toothpick member 570 pivots from the non-use first position to a second use position. In this use position, first region 570 is disposed at an angle of about 75 degrees relative to front surface 512a of body 512. First region 572 can then be utilized to pick the user's teeth by inserting tip 572a thereof into an interproximal space between adjacent teeth. Body 512 is held substantially parallel to the outermost front surface of those teeth as is indicated by the positioning of floss pick 510a in FIG. 32. When the user has finished picking those teeth, they will move body 512 in a direction suitable to withdraw the tip 572a of first region 572 from between the adjacent teeth. If that is the only set of teeth that requires use of toothpick member 570 then the user will remove their index finger so that it no longer contacts second region 576. The spring tension in first and second bridge members 582, 584 that was caused by pivoting toothpick member 570 to the use position, is then released and toothpick member 570 rotates in the opposite direction causing first region 572 to rotate back into aperture 574 and into alignment with recessed region 522. In other words, toothpick member 570 moves back to the nonuse position.

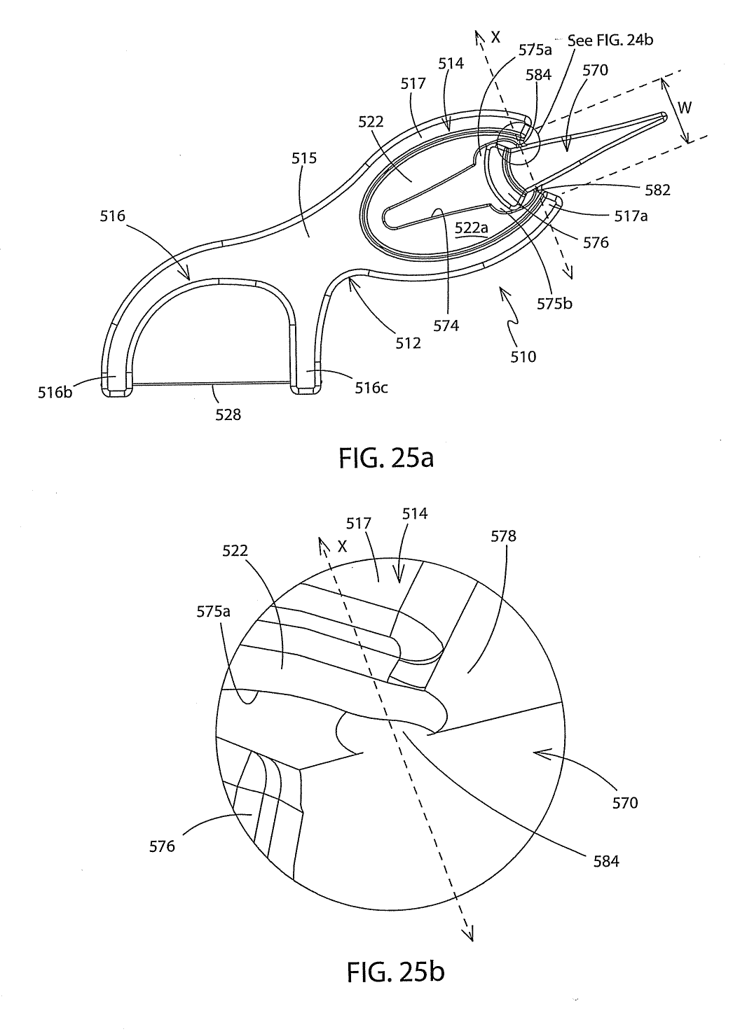

If there are additional teeth to be picked, instead of releasing second region 576, the user can continue to manipulate the same to change the angle of first region 572 to better approach an interproximal space in a second set of adjacent teeth. Again, the user will pivot toothpick member 570 by pushing or pulling second region 576 to pivot toothpick member 570 about the pivot axis “X” extending through first and second bridge members 582, 584. For instance, toothpick member 570 may be pivoted so that first region 572 is disposed at an angle of 90 degrees relative to front surface 512a as is shown in FIG. 27. Toothpick member 570 can then be used to pick the user's teeth in that different orientation by positioning body 512 slightly off parallel to the teeth as illustrated by floss pick 510b in FIG. 32. Once again, the index finger of the hand holding floss pick 510 will need to remain in contact with second region 576 to keep it from pivoting back to the nonuse position.

If the interproximal space to be picked is located in yet another set of adjacent teeth positioned in a different location in the user's mouth, it may be advantageous to have toothpick member 570 disposed at an even greater angle relative to front surface 512a than is shown in FIG. 27. The user will then continue to engage second region 576 and continue to pull it further in the direction indicated by arrow “G” thereby causing toothpick member 570 to pivot until first region 572 extends outwardly from front surface 512a at an angle of about 110 degrees relative thereto. Body 512 is positioned at a slight angle relative to the outer front surface of the teeth to be picked as is illustrated by floss pick 510c in FIG. 32.

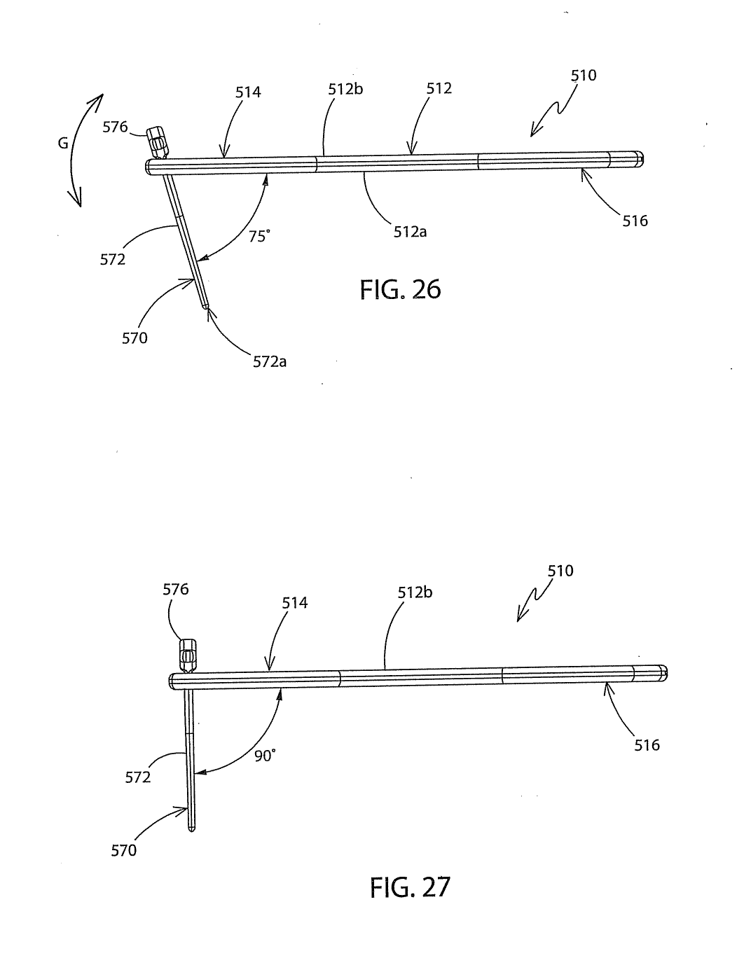

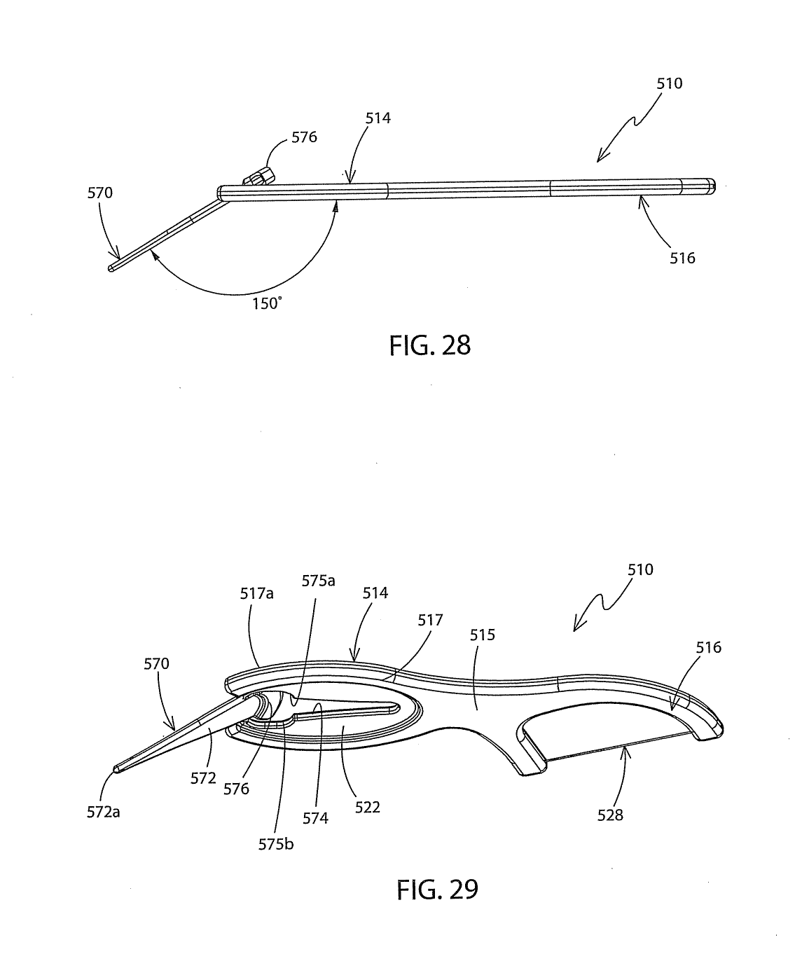

The user may position toothpick member 570 at an even greater angle relative to front surface 512a than in the previous example. This is done by continuing to pull on second region 576 with the index finger to move the same even further in the direction indicated by arrow “G”. FIGS. 28 and 29 show first region 572 disposed at an angle of 150 degrees relative to front surface 512a. In this instance, body 512 is positioned at an even greater angle relative to the outer front surface of the teeth to be picked as is illustrated by floss pick 510d in FIG. 32.

If the interproximal space is located in yet another position in the user's mouth, it may be advantageous to have the toothpick member 570 extend outwardly from the body 512 generally in alignment with front surface 512a. In order to swivel toothpick member 570 into this position, the user will pull second region 576 even further in the direction of arrow “G” beyond the position shown in FIG. 28. As second region 576 is pivoted into a third position where first region 572 is disposed at an angle of 180 degrees relative to front surface 512a, second region 576 enters the space in recessed region 522 created by first and second arcuate areas 575a, 575b and aperture 574. This is illustrated in FIG. 25a. When V-shaped first region 572 is disposed at 180 degrees relative to front surface 512a of body 512, i.e., first region is aligned with front surface 512a of body 512, second region 576 is disposed entirely within the space created by arcuate areas 575a, 575b and is also aligned with front surface 512a. When in this third position, the longitudinal axis of toothpick member 570 is coaxial with longitudinal axis “Y” of body 512. When first region 572 is disposed in this position, toothpick member 570 can be used in the traditional manner as would be a straight wooden toothpick. It should be understood that second region 576 of toothpick member 570 snap-fits into the space created by arcuate areas 575a, 575b and is retained therein by friction with those portions of body 512 that define aperture 574. This arrangement provides better stability of the toothpick member 570 during use. Additionally, when toothpick member 570 is in this position aligned with body 512 of floss pick 510, both longitudinal side surfaces of toothpick member 570 are able to be finger-contacted by the user. Thus, finger contact with both side surfaces of toothpick member 570 is possible during all modes of operation of the device. When toothpick member 570 is in the non-use position it is substantially aligned with body 512 and first and second bridge members 582, 584 are also planar and substantially aligned with body 412. When toothpick member 570 is in the use position illustrated in FIG. 25a, toothpick member 570 is again substantially aligned with body 512 and first and second bridge members are also aligned with body 512 but have a twisted spiral shape.

It will be understood that second region 576 can be engaged to move the V-shaped first region 572 into any one of a number of different angles between 0 degrees and 180 degrees relative to front surface 512a. Similarly, second region 576 can be moved in the opposite direction to that indicated by arrow “G”. This type of engagement will cause first region 572 to be disposed at an angle relative to rear face 512b of body 512. In particular, first region 572 may be disposed at any angle between 0 degrees and 180 degrees relative to rear face 512b. Although none of these alternative positions are illustrated in the figures, it will be understood that the alternative positions would be mirror images of those shown in FIGS. 25-29. As indicated previously, this ability to push or pull second region 576 so that first region 572 is disposed at an angle relative to either of the front and back surfaces 512a, 512b of body 512, enables the user to hold floss pick 510 in either hand. Preferably, during use of floss pick 510 the operational pick angle range is from approximately 75 degrees to approximately 180 degrees relative to one of the front and rear faces 512a, 512b of body 512. The index finger of the hand holding body 512 remains in contact during use of toothpick member 570.

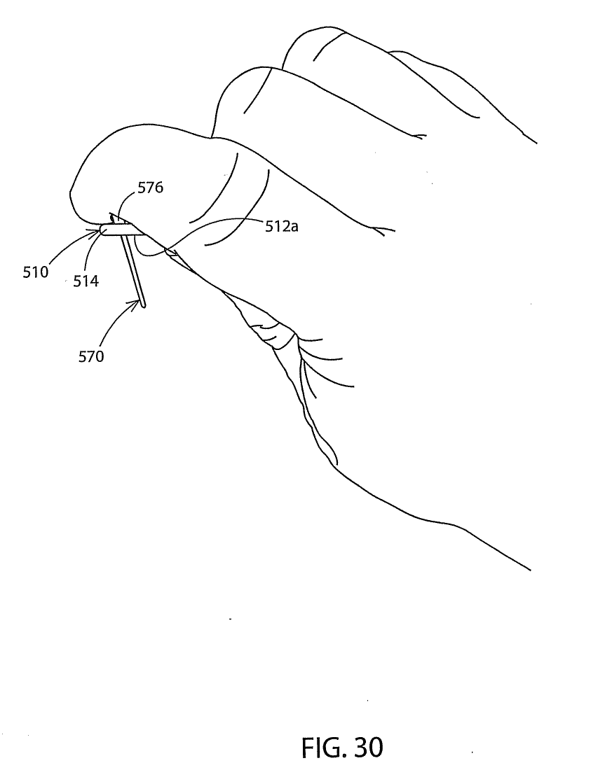

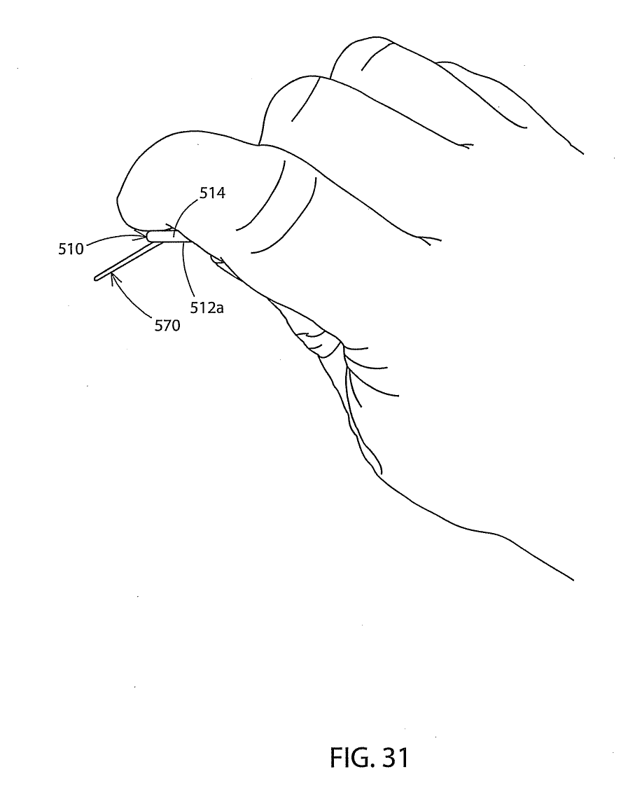

In accordance with the present invention, second region 576 is manipulated by engaging the same with a portion of the user's index finger while the user grasps handle 514 in the same hand. Thus, there is no need for the user to change their grip on the handle in order to differently orient first region 572 of toothpick member 570 relative to the body 512 during use. The ease of adjusting the position of toothpick member 570 is illustrated in FIGS. 30 and 31 where it is shown that the user's hand remains in substantially the same position relative to body 512 (except for a region of the index finger thereof), while the first region 572 of toothpick member 570 is moved from a first position where the first region 572 is disposed substantially at 75 degrees relative to the front face 512a, to a second position where first region 572 is disposed substantially at 150 degrees relative to front face 512a.

FIG. 32 shows how toothpick member 570 is rotated relative to front face 512a into different orientations so that it may be inserted into the interproximal spaces between adjacent teeth at different locations in the user's mouth. The user's hand has been removed from this illustration for the sake of clarity but it should be understood that each of the illustrated positions shows the floss pick held in the same hand.

There are advantages that this floss pick with an attached pivotable toothpick member 570 has over previous devices. In some cultures it is commonplace to pick one's teeth frequently at and during every meal. However, it is considered to highly impolite to have others at the table observe this action. It is therefore quite common for a person to pick their teeth with a conventional wooden toothpick using one hand and to shield their mouth and picking hand with their other hand. Often, in order to be more discrete, they will break the wooden toothpick in half to make sure it is shorter so that they can more closely cover their mouth. The device of the present invention is especially advantageous in these cultures in that the toothpick member 570 has a unique ability to work sideways relative to the body 512 at a variety of angles which allows for a more ergonomic and more subtle picking action. Additionally, the user is able to subtly manipulate the second region 576 to adjust the angle of the toothpick member 570 using the index finger of the hand which is holding the pick. FIG. 32 illustrates the natural handle position of floss pick 510 during operation from both right-to-left jaw quadrants and how the handle position is always close to the user's face. This positioning allows the user to closely cover floss pick 510 with their other hand. Normally with a conventional straight toothpick, a right-handed user would have to switch hands or come from underneath the jaw in order to pick the left rear molars. As is evident from FIG. 32, it is not necessary for the user to switch hands when using floss pick 510. This again makes it easier for a user to floss their teeth in a less conspicuous manner. Additionally, the length of the toothpick member 570 approximates half of that of a conventional wooden toothpick. Floss pick 510 is therefore able to be used very discretely as the body of the floss pick is shielded by the picking hand and the toothpick member 570 is substantially shielded by the index finger of that hand.

It will be understood that while floss picks 410 and 510 have been described as having a V-shaped toothpick member 470, 570, substantially the entire body of the toothpick member does not need to be V-shaped. All that is needed is that the region of the toothpick member that will engage the user's teeth should be suitable to be inserted into an interproximal space and to lever debris and plaque therefrom.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A floss pick comprising:
a body including a handle and a head, wherein the head includes:
a first arm;
a second arm;
a cavity defined between an interior surface of the first arm and an interior surface of the second arm;
a first toothpick member extending outwardly from the interior surface of the first arm and into the cavity; where the first toothpick member is integral with the first arm; and wherein the first toothpick member and first arm are both fabricated from a first material; and
a sheath overlaying the first material of the first toothpick member; said sheath being fabricated from a second material that differs from the first material.

2. The floss pick as defined in claim 1, wherein the first material is a rigid material.

3. The floss pick as defined in claim 1, wherein the first material is a hard material.

4. The floss pick as defined in claim 1, wherein the first material is plastic.

5. The floss pick as defined in claim 1, wherein the second material is a flexible material.

6. The floss pick as defined in claim 1, wherein the second material is a resilient material.

7. The floss pick as defined in claim 1, wherein the second material is an elastomeric material.

8. The floss pick as defined in claim 1, wherein the first material is a relatively hard plastic and the second material is rubber.

9. The floss pick as defined in claim 1, wherein the first toothpick member is generally conical in shape.

10. The floss pick as defined in claim 1, wherein the sheath envelops an exterior surface of the first toothpick member.

11. The floss pick as defined in claim 1, further comprising a length of dental floss extending outwardly from a tip of the first toothpick member and toward an interior surface of the second arm.

12. The floss pick as defined in claim 11, wherein the first toothpick member further defines an interior bore which extends between a first end of the first toothpick member adjacent the first arm and the tip, and wherein a portion of the length of floss is received through the bore.

13. The floss pick as defined in claim 12, further comprising a second toothpick member which is integrally formed with the second arm and extends outwardly from the interior surface thereof; and wherein the length of floss extending outwardly from the first toothpick member is engaged with the second toothpick member.

14. The floss pick as defined in claim 13, wherein the length of floss extends between the tip of the first toothpick member and into a bore defined in the second toothpick member, where the bore in the second toothpick member extends from the tip thereof to an end adjacent the interior surface of the second arm.

15. The floss pick as defined in claim 13, wherein the second toothpick member is fabricated from the first material; and the floss pick further includes a second sheath engaged around the first material of the second toothpick member; and wherein the second sheath is fabricated from the second material.

16. The floss pick as defined in claim 14, further comprising:
a slot defined in the one of the first and second arms from which the toothpick member extends outwardly, and wherein the slot is in communication with the bore of the associated one of the first and second toothpick members; and wherein a second portion of the length of floss is received in the slot.

17. The floss pick as defined in claim 1, wherein the first toothpick member has a longitudinal axis that is generally aligned with an axis of the length of floss, and the first toothpick member further includes a longitudinally-extending first blade which extends outwardly from a generally conical surface of the first toothpick member; and the first blade extends radially outwardly away from and generally at right angles to a longitudinal axis of the toothpick member.

18. The floss pick as defined in claim 17, wherein the first blade is fabricated from the first material and a region of the sheath fabricated from the second material envelops an exterior surface of the first blade.

19. The floss pick as defined in claim 18, wherein the first blade has a length that extends from a first end of the first toothpick member adjacent the first arm to a tip remote therefrom, and wherein the first blade has a height as measured from a base adjacent the generally conical surface of the first toothpick member to an outermost edge, and wherein the height of the first blade tapers along its length from the first end of the first toothpick member to the tip thereof.

20. The floss pick as defined in claim 19, wherein the first blade is sinuous or planar along substantially its entire length.

21. The floss pick as defined in claim 1, wherein the body has a longitudinal axis extending from a first end of the head to a terminal end of the handle, and the handle has a front surface and a rear surface, and the front and rear surfaces are longitudinally aligned, and wherein the handle is oval in shape when viewed from the front.
